(19) United States
(12) Patent Application Publication
(10) Pub. No.: US 2024/0211910 A1
(43) Pub. Date: Jun. 27, 2024

(54) SYSTEMS AND METHODS FOR ENABLING NON-FUNGIBLE TOKENS (NFTs) IN A VIRTUAL/METAVERSE ENVIRONMENT

(71) Applicant: Rovi Guides, Inc., San Jose, CA (US)

(72) Inventors: Dhananjay Lal, Englewood, CO (US); Reda Harb, Issaquah, WA (US)

(21) Appl. No.: 18/086,915

(22) Filed: Dec. 22, 2022

(51) Int. Cl. G06Q 20/12; G06Q 20/08; G06Q 40/04

(52) U.S. Cl. CPC G06Q 20/1235; G06Q 20/0855; G06Q 40/04; G06Q 2220/10

(57) ABSTRACT

Systems and methods for enabling non-fungible tokens (NFTs) in a virtual or metaverse environment by connecting an NFT marketplace to the virtual or metaverse environment and providing tools to display, sell, broker, and trade NFTs based on matching of user interests is disclosed. The methods generate a weighted taxonomy based on NFTs displayed in the virtual environment. A new user's interest in the NFTs is determined in multiple ways, including if the new user owns NFTs that share characteristics with the taxonomy associated NFTs. A match is determined based on new user's interests in relation to the weighed taxonomy. Upon a match, guidance is provided for avatars of the new user and other NFT owners to virtually meet. Separate servers, locations, and ingress points may be determined to facilitate meetings and buy/sell discussions. If an NFT sale/trade is executed, the sale/trade is recorded in the blockchain.

### FIELD OF DISCLOSURE

Embodiments of the present disclosure relate to conducting non-fungible tokens (NFTs) transactions in a virtual or metaverse environment by connecting an NFT marketplace to the virtual or metaverse environment and providing tools for allowing display, selling, brokering, delegating, and trading of NFTs based on matching of user interests.

### BACKGROUND

Non-fungible tokens, also referred to as NFTs, have been on the rise because of their properties of verified ownership through cryptocurrency blockchains. These NFTs include collectibles (such as Pokemon™, BAYC™, Cryptopunks™), video game assets (such as Skins™), memes (such as by tweets, blogs, Instagram posts), music, sports, videos, digital fashion, virtual land, and more. They also include latest sports actions, such as a short clip (e.g., captured by a fan) of an NBA™ player making a dunk in a specific NBA™ game that occurred in the real world or a latest goal in FIFA™ world cup held in Qatar. Any digital item of value can be minted into an NFT. Even real-world items can be minted into NFTs provided a custodian of the real-world item exists.

As items that can be displayed and traded, NFT sale and ownership is verified because each transaction related to an NFT is publicly available. For example, an NFT traded in Ethereum cryptocurrency is immutably recorded on the Ethereum blockchain. Consensus algorithms ensure that the smart ledger entry becomes the ground truth. Marketplaces like OpenSea™ and Rarible™ enable viewing (metadata), bidding-on and sale/purchase of NFTs.

Although NFTs are popular in the online space, they are still not present in the virtual or metaverse space, and even if they are, it is at their infancy. As it is commonly understood, Metaverse is referred to as a hypothetical iteration of the Internet, which may be as a single, universal, and immersive virtual world that is visualized by the use of virtual reality (VR) and augmented reality (AR) devices. In other words, it is used commonly in the context of as a network of 3D virtual worlds focused on social connection.

Unlike the real-world, the virtual world and metaverse presents many challenges that have not yet been analyzed for NFTs. As such, there is a need for a robust system that allows NFT transactions in the virtual and metaverse space.

### BRIEF DESCRIPTION OF THE FIGURES

The various objects and advantages of the disclosure will be apparent upon consideration of the following detailed description, taken in conjunction with the accompanying drawings, and in which:

FIG. 1 is a block diagram of a process for facilitating an NFT transaction in a virtual/metaverse environment based on matching of interests, in accordance with some embodiments of the disclosure;

FIG. 2 is a block diagram of a process for delegating an NFT to another user for brokering, in accordance with some embodiments of the disclosure;

FIG. 3 is a block diagram of a system for enabling NFTs and facilitating an NFT transaction in a virtual/metaverse and delegating an NFT to another user for brokering, in accordance with some embodiments of the disclosure;

FIG. 4 is a block diagram of an electronic device for enabling NFTs and facilitating an NFT transaction in a virtual/metaverse and delegating an NFT to another user for brokering, in accordance with some embodiments of the disclosure;

FIG. 5 is an example of an electronic device used in the virtual/metaverse environment for performing NFT transactions, in accordance with some embodiments of the disclosure;

FIG. 6 is a flowchart of a process for executing NFT transactions in a virtual/metaverse environment, in accordance with some embodiments of the disclosure;

FIG. 7 is a flowchart of a process for updating NFT taxonomy as new users are added, in accordance with some embodiments of the disclosure;

FIG. 8 is an example of avatars of multiple users coming face to face in a virtual or metaverse environment, in accordance with some embodiments of the disclosure;

FIG. 9 is an example of presentation of an NFT in the virtual or metaverse environment, in accordance with some embodiments of the disclosure;

FIG. 10 is an example of displaying metadata related to an NFT when a second user hovers or interacts with the NFT in the virtual or metaverse environment, in accordance with some embodiments of the disclosure;

FIG. 11 depicts examples of categories that may be explored to determine a weighted score for the NFT, in accordance with some embodiments of the disclosure;

FIG. 12 depicts layers in a taxonomy tree and the weighted score of some exemplary NFTs in the tree, in accordance with some embodiments of the disclosure;

FIGS. 13-15 depict examples of taxonomy trees, in accordance with some embodiments of the disclosure;

FIG. 16 is an example of a virtual or metaverse environment where multiple users may meet each other to facilitate an NFT transaction, in accordance with some embodiments of the disclosure;

FIG. 17 is an example of visual cues provided to a user to navigate in the virtual or metaverse environment to meet another user that has common interests in NFTs, in accordance with some embodiments of the disclosure;

FIG. 18 is a flowchart of a process of communications between a buyer, seller, metaverse application, and NFT marketplace to execute an NFT transaction, in accordance with some embodiments of the disclosure;

FIG. 19 is an example of rights provided to a broker to execute an NFT transaction, in accordance with some embodiments of the disclosure; and

FIG. 20 is a flowchart of a process of communications between a buyer, seller, delegate (broker), metaverse application, and NFT marketplace to execute an NFT transaction, in accordance with some embodiments of the disclosure.

### DETAILED DESCRIPTION

In accordance with some embodiments disclosed herein, some of the above-mentioned limitations are overcome by detecting linking of crypto wallet account that is associated with NFTs with a virtual or Metaverse account, determining that a plurality of NFTs from the crypto wallet account are displayed, generating a weighted taxonomy for the NFTs displayed, determining interest of a new user in relation to the taxonomy of NFTs generated, determining a match based on the interest and the taxonomy, providing guidance for the new user and a user (or users) whose NFTs were used to create the taxonomy, executing an NFT sale or trade, and recording the transaction in blockchain. In one embodiment, providing guidance for the new user may include providing visual cues directing the user to a location where the new user can meet other user(s)/owners of NFT that share common interest in similar NFTs. The NFT marketplace may act as an intermediary, such as an escrow, when buyer funds and seller's NFT's are exchanged. By doing so, the NFT marketplace may ensure confidence in both the buyer and seller and funds and NFTs are verified prior to the transaction.

In some embodiments, instead of selling or trading the NFTs by themselves, the owner of the NFT may delegate its sale or trade to a broker. The owner may designate all or some of the NFTs owned to the broker and provide certain rights under which the broker may operate to display, sell, and trade the NFT for the owner. In some embodiments, the right may limit the broker to display and advertise the NFTs earmarked for brokering and in other embodiment, additional rights may be provided to negotiate a deal with a prospective buyer or determine a sale price or appropriate trade. In some instances, an approval may be required from the owner prior to the broker executing the trade. In other instances, the owner may have an agreement with the broker to negotiate on their behalf based on acceptable, preconfigured parameters.

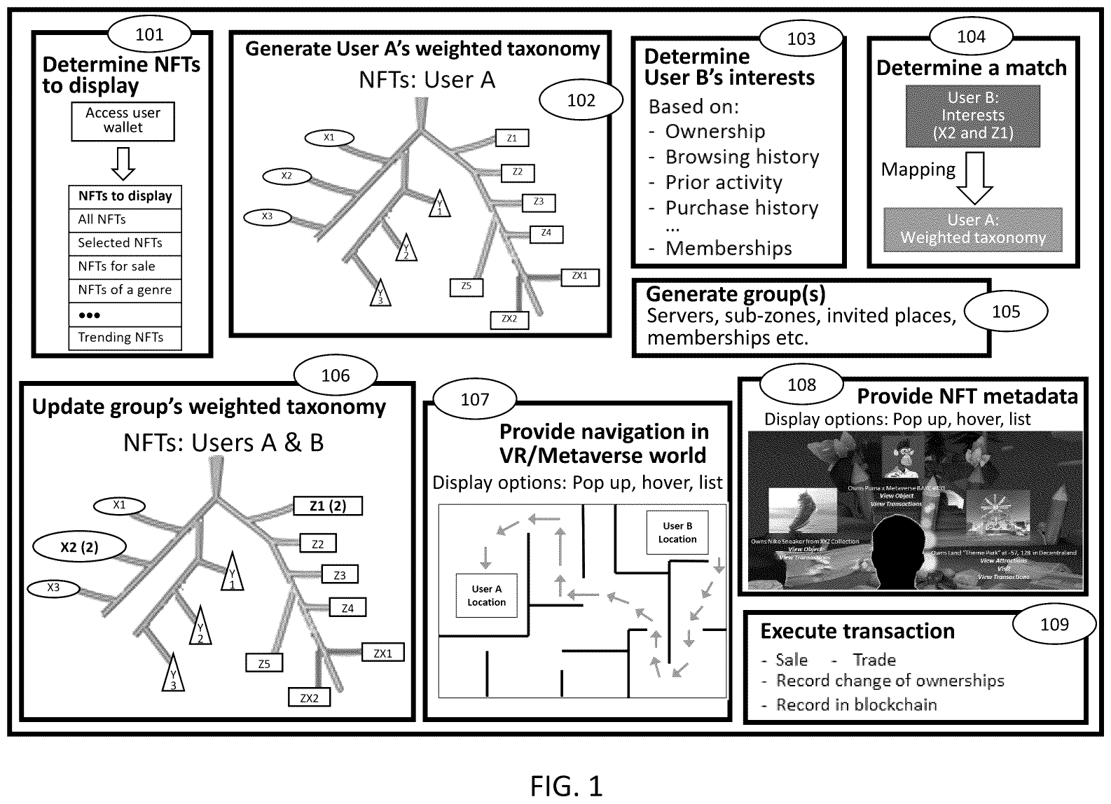

FIG. 1 is a block diagram of a process for enabling NFT marketplace in a virtual or metaverse environment, in accordance with some embodiments of the disclosure. More specifically, the process enables NFT sales, trading, and management in the virtual or metaverse environment. The process also enables review of metadata associated with the NFT prior to a buy-sell or trade transaction. As used herein, the metaverse is any immersive social world that allows users to interact with each other in an environment that is at least partially 3D, including games. Examples of such worlds are Second Life™, VRChat™ AltSpaceVR™, Roblox™, Fortnite™, Decentraland™, and SandboxVR™.

In some embodiments, at block 101, a determination is made to display non-fungible tokens (NFTs) owned by a user, such that the displayed NFT's can be viewed by interested buyers or interested users that are looking to trade/swap NFTs. Essentially, the NFTs can be publicly available for viewing (e.g., in the marketplace or any virtual world) by anyone interested.

An owner of an NFT has rights to transfer the token to their digital wallet, which is a crypto wallet, and store the NFT. The token proves that the owner has ownership rights of a digital file that is associated with the NFT, which is analogous to owning an original painting and having ownership rights therein. The owner may securely keep the token address in their crypto wallet confidentially and use their crypto key as a certificate of authenticity to validate that the owner in fact has ownership rights in the NFT.

In this embodiment, at block 101, the owner of the NFT links their Metaverse account with their Crypto wallet account. For example, the user may link their wallet, such as MetaMask™, TrustWallet™, Enjin™, or MyEther Account™ to their Metaverse account. Once linked, the NFTs associated with a user can be retrieved—when a user is within a virtual environment. An interested buyer may then be able to access the user's public wallet address to retrieve transactions that reveal ownership of NFTs.

As depicted at block 101, the owner can decide what NFTs from their collection to display or make viewable to the public. An owner may have configuration settings to control which NFTs to display to other users, or even to control which NFTs they want to be displayed from other users. For example, an owner who has 10 NFTs may only want to display 4 of the NFTs publicly as they are not interested in selling or trading the other 6 NFTs. In one embodiment, a user's configuration settings allow them to choose to display their NFTs only to friends, or to other users that have a trustworthiness score or rating greater than a threshold. In some embodiments, trustworthiness rating or score may be used to gauge the likelihood of a successful sale or trade of the NFT based on the buyer's and/or seller's transactions' history. In another embodiment, a user may choose to display their NFTs to others only if there is an interest match based on the type of NFTs owned by the target or potential buyer. In yet another embodiment, a second user may want to see NFTs of a first owner based on a price range in the configuration settings.

The owner may also decide to display all the NFTs owned by the seller or a limited sub-selection of NFTs owned. The owner may also decide to display NFTs in their collection based on the NFT genre, such as sports, their digital twin in the real-word, or a specific type, such as a Bored Ape™ etc. The owner may also decide to display NFTs that are trending, such as their category is currently hot or trending. Other variation on what to display and how long to display may also be configured by the owner. In other embodiments, the system, metaverse, or an artificial intelligence (AI) engine may make such display decision and place the NFTs for display.

At block 102, an NFT taxonomy is generated. It may be generated automatically when NFTs are displayed. The NFT taxonomy is a knowledge graph taxonomy that is used to categorize the user's NFTs. The taxonomy generated is User A's weighted taxonomy based on system NFT's taxonomy. As depicted, NFT's owned by User A are used to generate the NFT taxonomy. In this embodiment, User A owns three different genres of NFTs, which are type X, Y, and Z. There are further layers of NFTs within each genre, such as X1, X2, Y1, Z1 and so on the top layer and ZX1 and ZX2 in a sublayer.

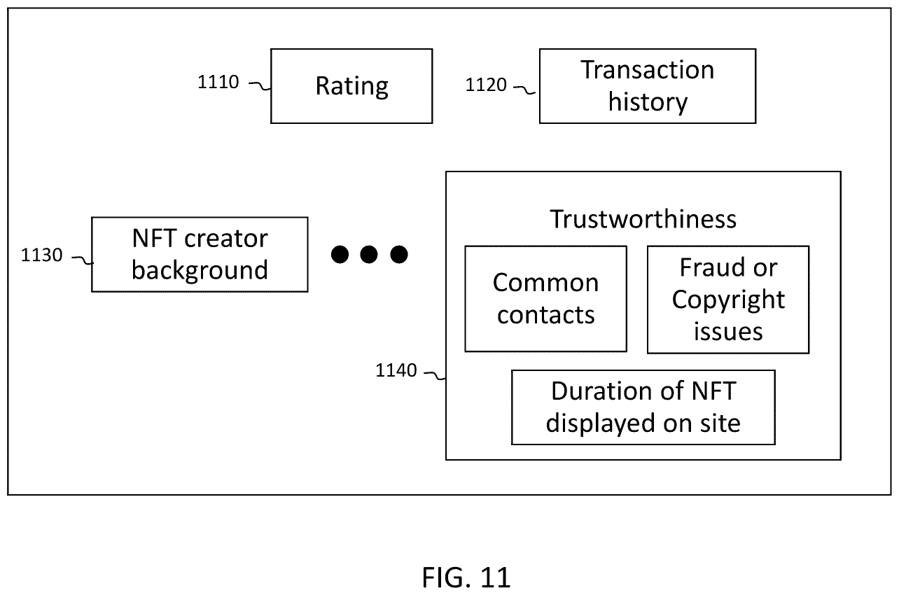

In some embodiments, the NFT taxonomy or knowledge graph is used to build the properties associated with each user's NFTs. This illustrates a non-exhaustive categorization of NFTs based on 2 levels. An exhaustive categorization may include more types and sublevels as described further in the description related to FIGS. 11-15.

In some embodiments, once an owner of the NFT links their Metaverse account with their Crypto wallet account, the NFTs associated with the owner are retrieved and categorized by the metaverse platform or a third party. In one embodiment, crowdsourcing may be used to categorize a user's NFTs. For example, a second user can be asked to categorize a first user's displayed NFTs. This can repeat until a clear winner (a mode in a distribution) is determined. In some embodiment, such a clear winner may be determined if predetermined number of users, such as 4, categorize the first user's displayed NFTs. In yet other embodiments, NFTs may also be categorized based on their metadata, such as description, title, or content. NFTs may also be categorized by associating them with their own category (e.g., trading cards, such as for NBA, hockey or other sports). They may also be categorized by each avatar in the virtual world. Although some example categorizations are described, the embodiments are not so limited and other types of categorizations are also contemplated.

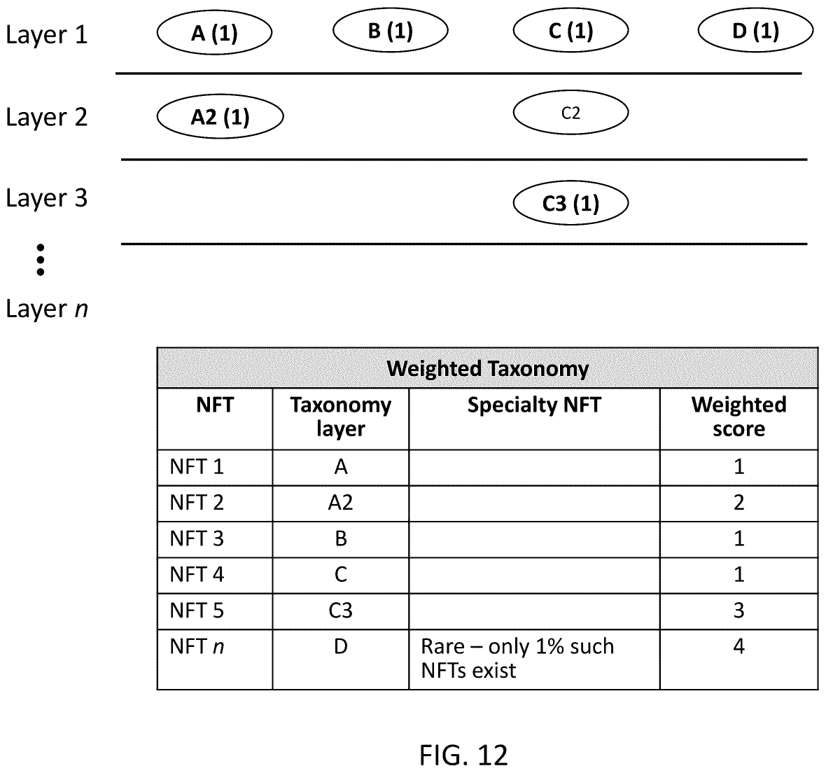

In some embodiments, the control circuitry 320 and/or 328 may assign the same weight to each NFT in the owner's crypto wallet for which a knowledge graph is created. In other embodiments, the deeper the sublayer of the NFT within a genre, the higher its weight. The control circuitry 320 and/or 328 may use such a method of assigning weights because an NFT that is 2 to 3 sublayers underneath the broad genre layer may be very specific and rare and as such they may be associated by the control circuitry with a higher NFT weighted value. Further details of weighting based on layer depth are described in connection with FIGS. 12-15 below.

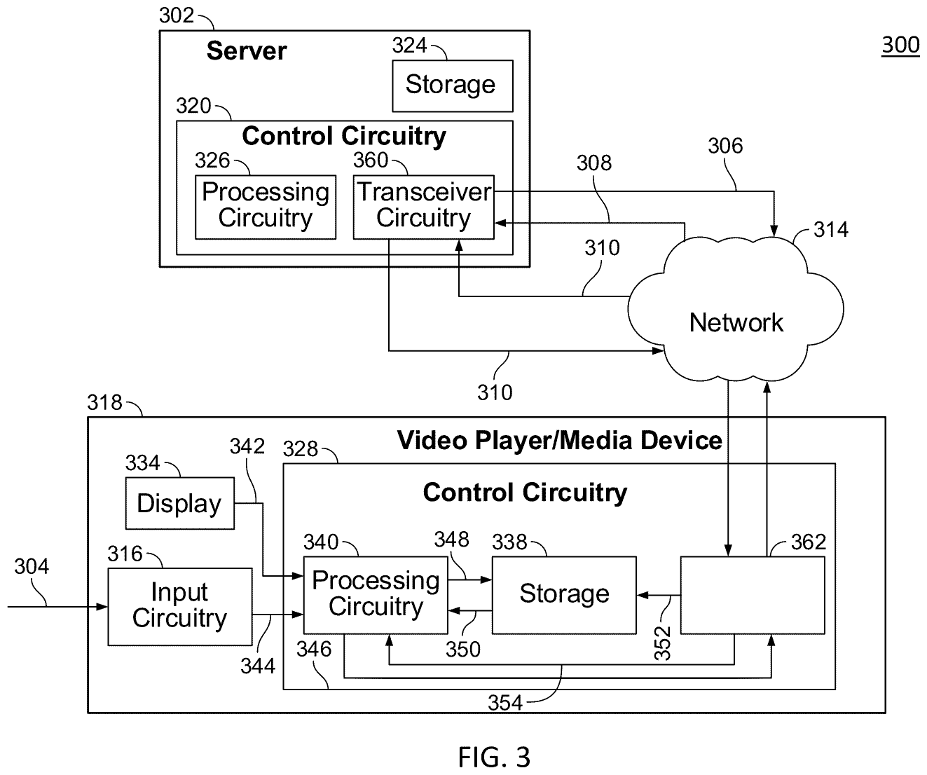

At block 103, the control circuitry, such as the control circuitry 320 and/or 328 from system depicted in FIG. 3, may determine another user, such as user B's interests. In one embodiment, user interest may be determined by the control circuitry 320 and/or 328 based on user B's NFT ownership. In this embodiment, user B may link their metaverse account with their crypto wallet account that includes NFTs that they own. Once linked, the NFTs associated with user B can be retrieved by the metaverse. Based on what NFTs are owned by user B, the control circuitry 320 and/or 328 may determine if user B may be interested in user A's NFTs that are displayed at block 101. For example, if user B owns an NFT that is in the same genre as user A, such as an NFT of an ape, Ferrari™, NBA™ player, the control circuitry 320 and/or 328 may determine that user B has interest in NFTs of such genre and is likely to have interest in user A's NFTs. In other words, because of user B's interest in NFTs of the same genre that are owned by user A, there is a likelihood that user B may be interested in buying, trading, or learning more about user A's NFTs.

In another embodiment, user interest may be determined by the control circuitry 320 and/or 328 based on user B's browsing history. In this embodiment, the control circuitry 320 and/or 328 may access user B's browsing history, such as which NFTs were browsed by user B. If user B accessed discord group or selected an NFT to obtain further information, such type of browsing may be captured by the control circuitry 320 and/or 328. If a determination is made that user B has browsed NFTs that are similar, in same genre, or share some characteristics with the NFTs owned by user A, then the control circuitry 320 and/or 328 may determine that user B has interest in user A's NFT.

In another embodiment, user interest may be determined by the control circuitry 320 and/or 328 based on user B's purchase history. In this embodiment, the control circuitry 320 and/or 328 may access user B's purchase and sale history to determine which NFTs were previously purchased, sold, traded by user B, even if user B no longer owns any NFTs. Such purchase history may be obtained by the control circuitry 320 and/or 328 by accessing blockchain transactions and searching for user B's transactions. If a determination is made that user B has bought, sold, or traded NFTs that are similar, in same genre, or share some characteristics with the NFTs owned by user A, then the control circuitry 320 and/or 328 may determine that user B has interest in user A's NFT.

In another embodiment, user interest may be determined by the control circuitry 320 and/or 328 based on membership, associations, or groups to which user B's belongs or is subscribed to. In this embodiment, the control circuitry 320 and/or 328 may access user B's online and virtual environment interactions to determine which memberships, associations, or groups to which user B's belongs or is subscribed to, such as a discord group for NFTs related to bored Apes™ or an invited group for individuals with interest in a particular genre of NFTs. If a determination is made that user B is subscribed to, visits an online page, or frequents at the online portal, for certain associations or groups that discuss, own, or present NFTs that that are similar, in same genre, or share some characteristics with the NFTs owned by user A, then the control circuitry 320 and/or 328 may determine that user B has interest in user A's NFTs. Likewise, if a determination is made that both user A and user B are subscribed to same NFT groups or associations, then the control circuitry 320 and/or 328 may determine that user B has interest in user A's NFTs.

In yet another embodiment, user B can specify which NFTs they're interested in. For example, user B can indicate in their profile the type of NFTs that they have interest in and whether their virtual world experience (e.g., recommended paths) should be impacted by NFTs. In another example, user B can provide an input via a keyboard, controller, associated with the XR device, or make a gesture while in the virtual world the types of NFTs of interest. The user B can also signal to the system that they would be interested in NFTs that another user, that they designate, such as their friend, is interested in. User B may also generate a Wishlist of NFTs. User B may also identify a creator, an artist, a user, or a company and indicate that when new NFTs by them are created, or posted publicly, i.e., by having their crypto wallets associated with the virtual world, then the system should notify them of such NFTs. By doing so User B can keep track of NFTs as they appear, especially from artists or User they like, so as not to miss out on such NFTs when they are public.

At block 104, a match between user B's interest and user A's NFTs is determined. The match may be determined by the control circuitry 320 and/or 328 if any one or more of the interests of user B match with NFT's owned by user A or delegated to user A, as described in block 103. In some embodiments, the control circuitry 320 and/or 328 may determine the level or degree of match. For example, the control circuitry 320 and/or 328 may determine if the match is at a very high level or is there a deeper match which increases the likelihood that user B would be interested in user A's NFTs.

In some instances, a high-level match may not be sufficient for the control circuitry 320 and/or 328 to determine that user B would be interested in user A's NFT to the degree that they would both want to meet or explore the potential of buying, selling, or trading NFTs with each other. Since the control circuitry 320 and/or 328 facilitates bringing together interested parties, such as user A and user B, for buying, selling, or trading NFTs, or even to explore and find further information about the NFT, the higher and deeper the match between user B's interests and user A's NFTs, the higher the likelihood and probability that user B would be interested in buying, selling, or trading NFTs with user A, or even exploring to find further information about the NFT. As such, may facilitate interactions or exchange of information when at least a threshold level of interest is determined.

In order to determine the degree of interest, in one embodiment, the control circuitry 320 and/or 328 may map user B's interest onto user A's taxonomy constructed at block 102. In some embodiments, the taxonomy created for user A's NFTs may associate all the NFT's with an equal weight. In other embodiments, the taxonomy created for user A's NFTs may—assign weight to each NFT based on their unique features and rarity. For example, if an NFT that is rare, such as only a handful of other NFTs that currently exists in the metaverse have similar attributes, then a higher weighted score may be assigned to such NFT. If an NFT of a bored ape has the ape wearing a very unique spacesuit that no other currently existing NFT has, then the NFT will be weighted at a very high score in the taxonomy. In some embodiments, the rarity of an NFT is determined by third parties such as Rarity Tools™ Rarity Super™ by using a bot command on their discord, howRare.is™ and others. The control circuitry 320 and/or 328 may access such third-party site (e.g., via an API) to check a rarity score of an NFT owned by user A and assign a weighted score based on the determined rarity. Other techniques may be used to assign a value or score to an NFT including using trained machine learning models that can weigh an NFT based on how similar are other NFTs in circulation. The score assigned to an NFT can be dynamic and may change as other NFTs become available in similar categories.

In yet another embodiment, as described at block 102, the control circuitry 320 and/or 328 may generate a knowledge graph taxonomy to categorize user A's NFTs. For the generated weighted taxonomy, in which a top layer is assigned broadly to a category and each sub-layer is a further refinement for more specific sub-categories that fall within the top layer category, the deeper the sub-layer, the higher the weight may be assigned to NFTs that fall in such sub-layers. For example, if the top layer, which may be layer 1, is assigned to cars, layer 2, is assigned to Ferraris, and layer 3 is assigned to certain vintage Ferraris that fall under very limited edition, then NFTs associated with Ferraris that fall in layer 3 will be assigned a higher weight than NFTs associated with cars that fall in layer 1.

Referring back to block 104, user B's interest may also be weighted similar to user A's NFTs and the deeper and more unique the interest, the higher the weighted score assigned.

At block 105, in some embodiments, once a determination is made that user B has interests, such as interests determined at block 103, that match with the NFT's owned by user A, then the control circuitry 320 and/or 328, at block 105, may assign both user A and user B to a specific server or group such that they may further explore their interests in each other's NFTs. The server, in one embodiment, may be selected by a metaverse app that uses a client-server architecture, such that connectedness (friends, friends of friends, etc.) amongst users is maximized. Accordingly, in one embodiment, a server may be selected for a new user seeking to join a social world such that there is maximum overlap between the users' NFT categories on a server in a sharded client-server architecture. In some embodiments, the rationale for generating the server or group is to place User A and User B together because they had the highest match and such grouping may result in a sale, trade, exchange of NFTs.

At block 106, user B's matched interests are associated with user A's weighted taxonomy (e.g., in a database). In other words, the group formed for which a weighted taxonomy is generated is the group represented in the block 102 and such group's weighted taxonomy is updated to reflect the addition of a new user, in this case user B, as depicted in block 106. Although the group in block 102 shows only one user, this is exemplary, and the group may consist of many users. Updating the weighted taxonomy of the entire group, server, zone, virtual invited place, or whatever the grouping may be named, helps make sure any subsequent users joining the virtual world are also matched to the right group. As used herein, in one embodiment, weighted taxonomy of a user is a knowledge tree that specifies all the weights associated with that user's owned NFTs based on the system-defined taxonomy. Similarly, the weighted taxonomy of a group, server, zone, virtual invited place etc. is a knowledge tree that specifies all the weights associated with all the users in that server/zone/invited place based on the system-defined taxonomy. The weighted taxonomy of a user can be used to determine that user's match with another user or a group by scoring the figure of merit between the 2 users' weighted taxonomies or the weighted taxonomy of the user with the weighted taxonomy of the group (server/zone/invited place etc.).

As depicted, user B may own NFTs X2 and Z1, or may indicate in their profile their interest in owning a specific type of NFT. After a match is determined, the group's weighted taxonomy is updated to reflect the addition of User B. Since User B also owns X2 and Z1, when added to the group, the updated weighted taxonomy depicts that User A and User B collectively have two NFTs that are X2 and two NFTs that are Z1. Although a same weight has been applied in this example to update the taxonomy at block 106, as mentioned earlier, different weights based on the uniqueness and rarity may be assigned. Additional details of associating weighted scores based on type of NFT is described in the discussion of FIG. 12.

Although only two users, user A and user B, have been discussed in the embodiments above, the embodiments are not so limited, and interests of multiple users may be determined and mapped onto the group's weighted taxonomy.

In some embodiments, when a new user requests to join the metaverse and links their metaverse account with their crypto wallet account that includes NFT that they own, then the metaverse app determines which server to assign to the new user based on the number of matches in the weighted taxonomy between the online users on existing servers and the new user. Each subsequent layer (depth) in the tree traversal cumulatively increases the match than the previous level.

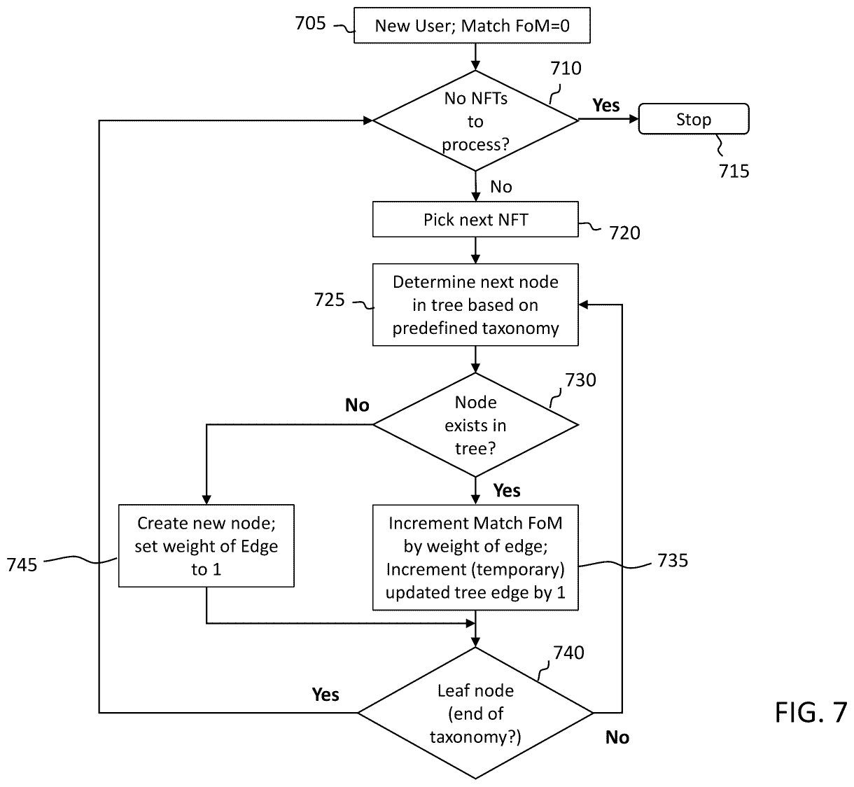

In some embodiments, the cumulative Match Figure of Merit (FoM) between a new user and the online server is determined. For example, a value of “2” for NFTs X2 and Z1 may be determined as depicted in block 105. When other weights are used based on NFT rarity, other cumulative values may be determined based on the weighted value assigned. The FOM for each online server is calculated and the new user is joined to the server with the highest Match FoM. If the user cannot join the highest match FoM due to system considerations (e.g., the server user capacity has already been reached), then the next highest FoM candidate server may be selected. Once the user joins a server, then the user's NFT ownership is used to update the knowledge graph for that server by following the process of FIG. 7.

At block 107, in one embodiment, the control circuitry 320 and/or 328 may determine that user A and user B are within a threshold distance of each other in the virtual world. For example, the user A and user B may be at a same virtual convention, at a same virtual event, or within a threshold distance of each other in another type of virtual space. Since both users A and B are in the virtual environment or metaverse via their extended reality headsets, user B may be able to virtually transport themselves to virtually meet user A.

Having determined that user B may be interested in user A's NFTs, or that both user A and user B are assigned to a server based on their common interests in NFTs, when the control circuitry 320 and/or 328 determines that users A and B are within a threshold distance of each other in the virtual world, the control circuitry 320 and/or 328 may guide them to meet each other in the virtual world. In one embodiment, the control circuitry 320 and/or 328 may recommend a path for user B's digital avatar in the metaverse and may offer user B tools to navigate in the virtual world such that the avatar of user B can reach the avatar of user A.

In one embodiment, the user may be able to see other NFT owners, with specific weighted taxonomy of their NFTs on a map of the virtual world. The user may also be offered a convenient way to teleport to the location of another NFT owner.

In another embodiment, a metaverse may have multiple entrances or portals where the user ingresses the social world. The control circuitry 320 and/or 328 may divide the social world into “sub-regions” or “zones” and determine the zone that has the highest match based on NFT ownership. The control circuitry 320 and/or 328 may allow a new user requesting entry into the virtual world, such as user B, such that user B can navigate to user A. The control circuitry 320 and/or 328 may deep-link user B to the portal of that zone, to ingress the virtual world. In this manner, the control circuitry 320 and/or 328 may optimize a new user location in close proximity to other users with matched (similar) NFT ownership or interest. For example, if multiple buyers are interested in multiple sellers or owners of NFTs, the control circuitry 320 and/or 328 may determine a new location for everyone to virtual meet.

In yet another embodiment, a social world may have specific regions or areas where users having a specific interest may congregate. For users with interest in fashion may congregate at a specific virtual location, such as a virtual fashion show, virtual fashion expo, etc. For example, a specific virtual room (sub-world) inside of the virtual world may be recommended by the online server where a high Match FoM NFT owner may be found. Certain spaces/rooms/zones in a metaverse may be reserved and available by invitation only to owners of specific NFT collections, or to high value NFT owners. The control circuitry 320 and/or 328 based on a user's NFT ownership or interest, may deep-link them directly into an ingress point for the specific area of high match or to the specific room, zone, or space. Doing so would allow the users to meet at the ingress point or at the specific area of high match rather than have the user try to navigate on their own or virtually walk long distance to get to the high match area.

In yet another embodiment, the control circuitry 320 and/or 328 may calculate a path for a new user such that the new user visits one or more NFT owners that match their interest. Various techniques, such as shortest path algorithms e.g., Djikstra's and A*, may be used by the control circuitry 320 and/or 328 to calculate a path for users to meet. The control circuitry 320 and/or 328 may also provide options for users to stop at other intermediate destinations that are also designated as a high Match FoM for users with similar NFT interests or ownerships. For example, if the destination for users is to be transported to an area where NFT owners, or users with interests in such NFTs, for example, in Ferrari NFTs will congregate, then any intermediate spots where other groups such as users with ownership or interest in other types of sports cars that are along the way may be identified to the users if they wish to stop at those intermediate locations before reaching the final destination.

As depicted by the arrows at block 107, in some embodiments, the control circuitry 320 and/or 328 may provide visual cues in the virtual world to traverse the path that maximizes their visit/proximity to the high Match FoM NFT owners. In some embodiments, the control circuitry 320 and/or 328 may calculate the shortest path and then use the visual cues, such as arrows, to guide user B, or multiple users to the meeting location.

In some embodiments, the virtual world may be small enough that a map and teleporting may not be necessary, or the user may have turned off these features based on their preference. In such embodiments, users may look at the map and navigate to the meeting location on their own. User may also be given an option to select their own meeting space and inform other users of similar interests in the NFTs to meet at the selected location.

At block 108, when the users come in view of each other, various display options may be used to display the NFTs to each other and to identify mutual interest. For example, in one embodiment, when a user hovers their controller or mouse over another user's NFT to get information, the control circuitry 320 and/or 328 may display metadata associated with the NFT. Hovering, selecting, or gazing at the NFT by a user may reveal more information about that NFT. In another embodiment, when a user using their extended reality headset gazes over another user's NFT, the control circuitry 320 and/or 328 may display metadata associated with the NFT.

In some embodiments, display options, for example as depicted at block 108, may be available to users only when the users via their avatars come virtually face to face in the virtual world or are in close proximity such that they are visible to each other.

In other embodiments, display options, for example as depicted at block 108, may be available to users even when they are not virtually face to face in the virtual world or are in close proximity such that they are visible to each other in the virtual world. In this embodiment, the user may not be able to gaze or hover over the other user's NFT since they are not virtually face to face in the virtual world or are in close proximity, however, the user may request a list of all matches and may select any NFT on the list to display same metadata as they would have seen if they were virtually face to face in the virtual world or are in close proximity to the other user's avatar.

The metadata that may be displayed in relation to NFT displayed at block 108 may include trustworthiness ranking, NFT seller rating/score, cost of purchase, gas fees associated with NFT, details of creator, attributes of the NFT, such as color and features, its rarity, any groups or discord platforms associated with the NFT, and any other information that the creator of the NFT or the system associates with the NFT.

In one embodiment, trustworthiness ranking may be assigned to the NFT or its owner based on the NFT owner's prior transaction(s). The trustworthiness ranking may also inform the buyer whether there are any copyright, fraud, or other malicious issues with the NFT or its owner. For example, one of the reasons for lack of trustworthiness is a transaction may be related around centralized file storage, where an NFT marketplace may not have paid their dues to keep the asset online in a cloud file system. Since the NFT in some embodiments is a digital artwork, which is not located or registered on the blockchain, but rather an image hosted elsewhere, the trustworthiness ranking may also inform the buyer the level of trust to have in the hosted site that the hosted site will not remove the NFT soon after purchase. Such determination may be based on the hosted sites reputation, prior transactions, reviews etc.

At block 109, an interested user, such as user B, may purchase or trade the NFT after reviewing the related metadata. In order for the sale or trade to execute, in one embodiment, a metaverse/social world app may communicate with a NFT marketplace via an API. The metaverse app may have APIs with multiple NFT marketplaces. The API communication may occur between the metaverse platform and the marketplace where the NFT has been offered for sale.

In one embodiment, upon completion of the sale, purchase, or trade of NFT, the transaction may be recorded on the cryptocurrency blockchain and contain a link (url) to the actual asset where it is hosted. Such recording may inform other users of the ownerships rights in the NFT.

Upon the completion of the transaction, in some embodiments, the user may also be able to rate the NFT seller and the marketplace based on how smoothly the transaction went, and whether their NFT remained online well after the transaction. Through this rating mechanism, and as the NFT seller and platform continues to sell or trade more NFT, the trustworthiness of NFT sellers and marketplaces may continue to be reliable if many users have added their rating based on their transaction experience. This trustworthiness ranking can be displayed to potential buyers in the metaverse, thus helping them to decide whether they want to proceed with the transaction with a specific seller, using a specific marketplace.

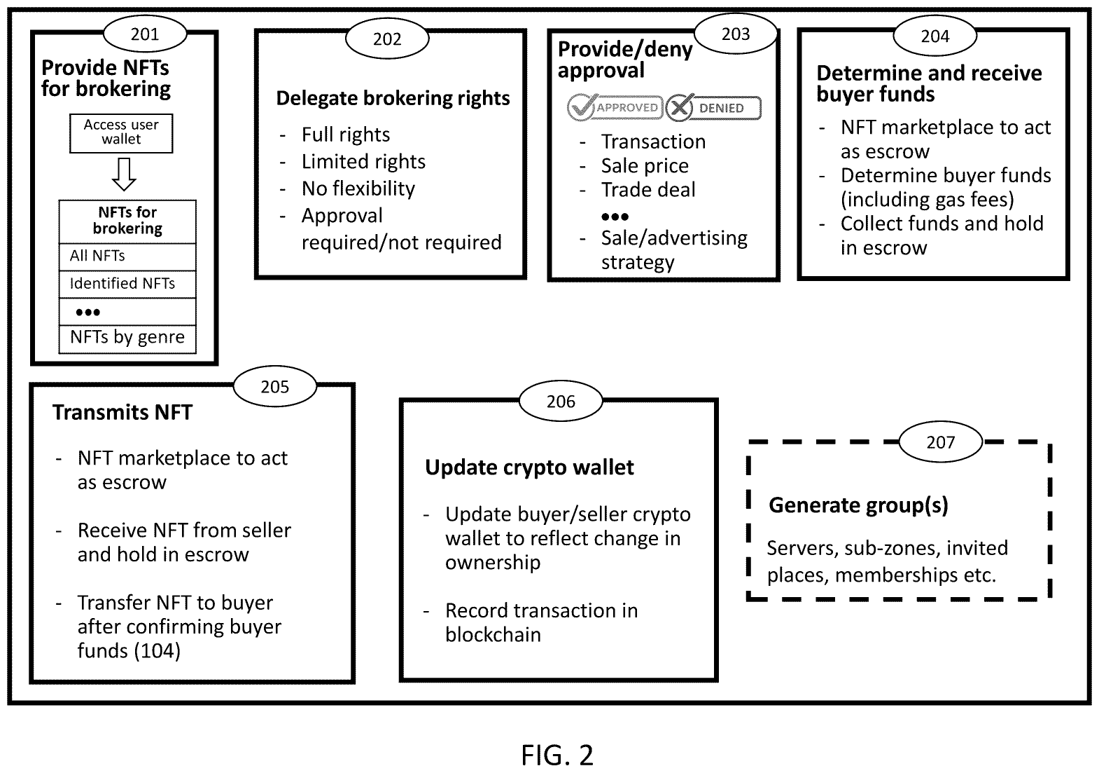

FIG. 2 is a block diagram of a process for delegating an NFT to another user for brokering, in accordance with some embodiments of the disclosure. In this embodiment, an owner of an NFT may delegate sale or trade of an NFT to another individual or third-party. Such individual or third-party may be a celebrity, an influencer, someone expert in a field, or an auction house, collectively referred to herein as an NFT broker.

At block 201, in some embodiments, the owner may decide which NFTs to delegate for brokering. For example, the owner may delegate all of some of the NFTs to the NFT broker. They may delegate NFTs in their collection based on the NFT genre, such as sports, their digital twin in the real-word, or a specific type, such as a Bored Ape™ etc. The owner may also decide to delegate those NFTs that are trending or popular.

Upon receiving a delegation from the owner, the broker may access the NFTs earmarked for brokering by accessing the owner's public wallet to retrieve data related to the NFT. In some embodiments, the NFT and ownership may remain with the owner and the rights transferred to the broker may be to only display and broker the NFT, i.e., no ownership rights may be provided.

At block 202, the owner of the NFT may provide certain rights to the broker for brokering a transaction for the NFTs earmarked by the owner for brokering. In one embodiment, the owner may provide a full set of rights to the broker for brokering a transaction for the NFTs. The full set of rights may allow the broker to determine a price or negotiate a deal and determine which of the NFTs identified by the owner to sell or trade to another user.

In another embodiment, the owner of the NFT may provide certain limited rights to the broker. The broker may only exercise their brokering duties in accordance with the limited rights provided. For example, the owner of the NFTs may be given a price window within which to sell the NFT and the limited rights may allow the broker to negotiate a sale price as long as it is within the window provided.

In yet another embodiment, the owner of the NFT may not provide any flexibility to the broker in terms of sale price, negotiations, or which NFT to trade. The broker may only be able to display and advertise the NFTs and then execute a transaction within the allotted rights.

In another embodiment, the owner of the NFT may requires approval for certain transactions as depicted at block 203. The broker may be required to obtain approvals from the NFT owner prior to executing the transaction. Such approvals may include an approval if there's a change in sale price, transaction details, which NFT is to be traded, or sale/advertising strategy, such as where to display the NFTs or what types of advertising campaigns to use.

At block 204, once a broker identifies a user that is ready to transact, such as to buy or trade an NFT owned by the owner, and the broker has complied with the delegated rules from block 202 and received any approvals that may be needed from the buyer in block 203, the control circuitry 320 and/or 328 may designate the system associated with the marketplace to act as a neutral intermediary party for the transaction. The system associated with the marketplace may act as an escrow to ensure that both parties, the buyer and seller, receive as negotiated for the transaction. Accordingly, the system associated with the marketplace may receive and hold the buyer's funds. The system associated with the marketplace may also ensure that the funds include any gas fees, which is a payment for the network that is used for the NFT transaction, such as Ethereum™.

At block 205, the system associated with the marketplace receives the NFTs from the owner directly, not from the broker. In other embodiments, the owner may give rights to the broker to initiate the transfer of the NFT. The system associated with the marketplace may perform the transaction by transferring the NFTs to the buyer and the funds for the NFT to the seller.

At block 206, upon completion of the transaction, the crypto wallets of the buyer and seller may be updated. The transaction may be recorded in the blockchain and the ownership rights for the NFTs may also be recorded to the new buyer.

At block 207, in some embodiments, specific servers, sub-zones, or invited places may be designated for buyers and sellers of a genre of NFT, or buyers and sellers that have mutual NFT interest, to meet or exchange information relating to any additional NFTs for trade or sale.

In some embodiments, an owner of an NFT may delegate their NFTs for brokering to a second user (broker) on an NFT exchange. For example, once the second user has wallet with his own NFTs, a section of NFTs may be designated for those NFTs that are delegated to them. In another example, the NFT exchange may notify the second user that a delegation is being made to them and ask them to approve the delegation. Other methods of delegation may also be contemplated. In some embodiments, the delegation may be private or public as selected by the owner. The delegation may allow the broker to sell, trade, or exchange NFTs with another user. In some embodiments, the control circuitry, such as via a recommendation from an AI engine may recommend delegation of NFTs from the owner to a broker. The control circuitry may determine that the broker, who may be an influencer or celebrity or someone expert in the field, may be suitable for brokering the NFTs. Such recommendation may be approved by the owner to automatically delegate the NFTs to the recommended broker. In some embodiment, brokering agreements, commissions, and other contract details may be automatically provided for approval by owner and broker, which may be negotiated.

FIG. 3 is a block diagram of a system for enabling NFTs and facilitating an NFT transaction in a virtual/metaverse and delegating an NFT to another user for brokering, in accordance with some embodiments of the disclosure.

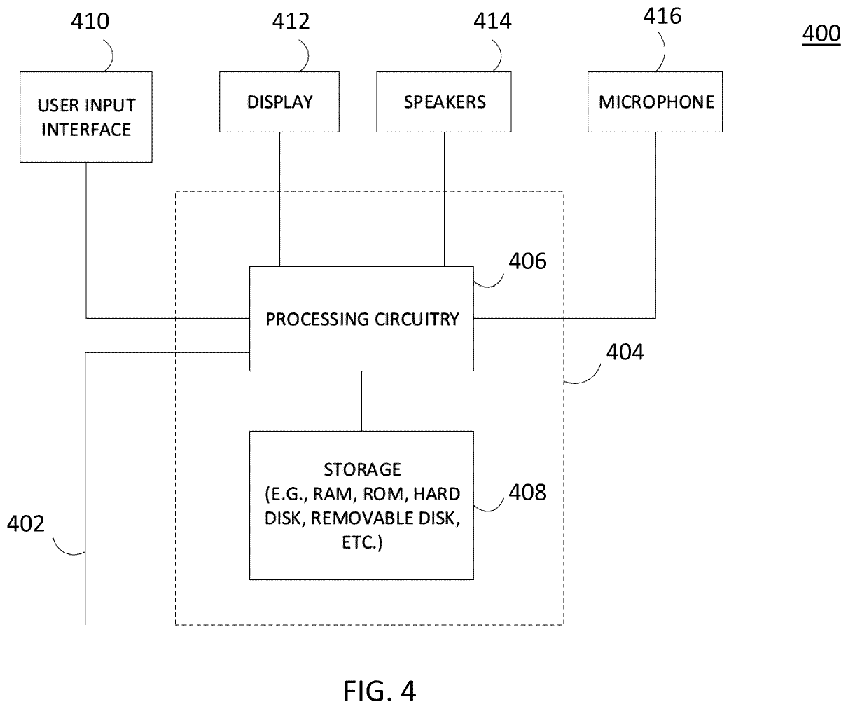

FIGS. 3 and 4 also describe example devices, systems, servers, and related hardware that may be used to implement processes, functions, and functionalities described at least in relation to FIGS. 1, 2, 6-15, and 17-20. Further, FIGS. 3 and 4 may also be used for detecting linking of crypto wallet account that is associated with NFTs with a virtual world or Metaverse account, determining that a plurality of NFTs from the crypto wallet account are displayed, generating a weighted taxonomy for the NFTs displayed, determining interest of a new user in relation to the generated weighted taxonomy of NFTs, determining a match based on the interest and the taxonomy, providing guidance for the new user and a user (or users) whose NFTs were used to create the weighted taxonomy, executing an NFT sale or trade, recording the transaction in blockchain, configuring the NFT marketplace to act as an intermediary, updating taxonomies, determining weights for taxonomies, delegating sale or trade of NFT to a broker, determining delegation rights provided o the broker, determining approvals required for broker to conduct the NFT transaction, approving or denying transactions, allocating servers and virtual locations for interested users to meet, guiding users via visual cues, deep-linking users to an egress of a location to meet and performing functions related to all other processes and features described herein.

In some embodiments, one or more parts of, or the entirety of system 300, may be configured as a system implementing various features, processes, functionalities and components of FIGS. 1, 2, 6-15, and 17-20. Although FIG. 3 shows a certain number of components, in various examples, system 300 may include fewer than the illustrated number of components and/or multiples of one or more of the illustrated number of components.

System 300 is shown to include a computing device 318, a server 302 and a communication network 314. It is understood that while a single instance of a component may be shown and described relative to FIG. 3, additional instances of the component may be employed. For example, server 302 may include, or may be incorporated in, more than one server. Similarly, communication network 314 may include, or may be incorporated in, more than one communication network. Server 302 is shown communicatively coupled to computing device 318 through communication network 314. While not shown in FIG. 3, server 302 may be directly communicatively coupled to computing device 318, for example, in a system absent or bypassing communication network 314.

Communication network 314 may comprise one or more network systems, such as, without limitation, an internet, LAN, WIFI or other network systems suitable for audio processing applications. In some embodiments, system 300 excludes server 302, and functionality that would otherwise be implemented by server 302 is instead implemented by other components of system 300, such as one or more components of communication network 314. In still other embodiments, server 302 works in conjunction with one or more components of communication network 314 to implement certain functionality described herein in a distributed or cooperative manner. Similarly, in some embodiments, system 300 excludes computing device 318, and functionality that would otherwise be implemented by computing device 318 is instead implemented by other components of system 300, such as one or more components of communication network 314 or server 302 or a combination. In still other embodiments, computing device 318 works in conjunction with one or more components of communication network 314 or server 302 to implement certain functionality described herein in a distributed or cooperative manner.

Computing device 318 includes control circuitry 328, display 334 and input circuitry 316. Control circuitry 328 in turn includes transceiver circuitry 362, storage 338 and processing circuitry 340. In some embodiments, computing device 318 or control circuitry 328 may be configured as electronic device 400 of FIG. 4.

Server 302 includes control circuitry 320 and storage 324. Each of storages 324 and 338 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 324, 338 may be used to store various types of content (e.g., videos, content items, 360° videos, extended reality experiences, discomfort trends, discomfort trend thresholds, desired content discomfort ratings, discomfort level or comfort range, discomfort ratings, biometric or biomarker data related to one or plurality of users, backgrounds, profiles of a plurality of users, content altering options, list of alternate versions of same content, body devices configurations, virtual reality applications, and AI and ML, algorithms). Non-volatile memory may also be used (e.g., to launch a boot-up routine, launch an app, render an app, and other instructions). Cloud-based storage may be used to supplement storages 324, 338 or instead of storages 324, 338. In some embodiments, data relating to NFTs, weighted taxonomy, user interests, matching between new and existing users, trustworthiness ratings, weighted taxonomy trees, meeting locations in the virtual world, avatars that represent the users and data relating to all other processes and features described herein, may be recorded and stored in one or more of storages 312, 338.

In some embodiments, control circuitries 320 and/or 328 executes instructions for an application stored in memory (e.g., storage 324 and/or storage 338). Specifically, control circuitries 320 and/or 328 may be instructed by the application to perform the functions discussed herein. In some implementations, any action performed by control circuitries 320 and/or 328 may be based on instructions received from the application. For example, the application may be implemented as software or a set of executable instructions that may be stored in storage 324 and/or 338 and executed by control circuitries 320 and/or 328. In some embodiments, the application may be a client/server application where only a client application resides on computing device 318, and a server application resides on server 302.

The application may be implemented using any suitable architecture. For example, it may be a stand-alone application wholly implemented on computing device 318. In such an approach, instructions for the application are stored locally (e.g., in storage 338), and data for use by the application is downloaded on a periodic basis (e.g., from an out-of-band feed, from an internet resource, or using another suitable approach). Control circuitry 328 may retrieve instructions for the application from storage 338 and process the instructions to perform the functionality described herein. Based on the processed instructions, control circuitry 328 may determine a type of action to perform in response to input received from input circuitry 316 or from communication network 314. For example, in response to determining that an owner/user has displayed certain NFTs, the control circuitry may automatically generate a weighted taxonomy tree that is based on the NFTs displayed. It may also perform steps of processes described in FIGS. 1-2, 6-7, 18 and 20, including determining matches between a new user and a single or group of existing users that own NFTs.

In client/server-based embodiments, control circuitry 328 may include communication circuitry suitable for communicating with an application server (e.g., server 302) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 314). In another example of a client/server-based application, control circuitry 328 runs a web browser that interprets web pages provided by a remote server (e.g., server 302). For example, the remote server may store the instructions for the application in a storage device. The remote server may process the stored instructions using circuitry (e.g., control circuitry 328) and/or generate displays. Computing device 318 may receive the displays generated by the remote server and may display the content of the displays locally via display 334. This way, the processing of the instructions is performed remotely (e.g., by server 302) while the resulting displays, such as the display windows described elsewhere herein, are provided locally on computing device 318. Computing device 318 may receive inputs from the user via input circuitry 316 and transmit those inputs to the remote server for processing and generating the corresponding displays. Alternatively, computing device 318 may receive inputs from the user via input circuitry 316 and process and display the received inputs locally, by control circuitry 328 and display 334, respectively.

Server 302 and computing device 318 may transmit and receive content and data such as buyer interest, seller NFTs, NFT metadata, price queries, bids, trustworthiness scores and input from XR devices. Control circuitry 320, 328 may send and receive commands, requests, and other suitable data through communication network 314 using transceiver circuitry 360, 362, respectively. Control circuitry 320, 328 may communicate directly with each other using transceiver circuits 360, 362, respectively, avoiding communication network 314.

It is understood that computing device 318 is not limited to the embodiments and methods shown and described herein. In nonlimiting examples, computing device 318 may be an electronic device, a personal computer (PC), a laptop computer, a tablet computer, a WebTV box, a personal computer television (PC/TV), a PC media server, a PC media center, a handheld computer, a mobile telephone, a smartphone, a virtual, augmented, or mixed reality device, or a device that can perform function in the metaverse, or any other device, computing equipment, or wireless device, and/or combination of the same capable of suitably determining desired content discomfort ratings, displaying content items, an selecting versions of contents items to be displayed.

Control circuitries 320 and/or 318 may be based on any suitable processing circuitry such as processing circuitry 326 and/or 340, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitries 320 and/or control circuitry 318 are configured for detecting linking of crypto wallet account that is associated with NFTs with a virtual world denying transactions or Metaverse account, determining that a plurality of NFTs from the crypto wallet account are displayed, generating a weighted taxonomy for the NFTs displayed, determining interest of a new user in relation to the generated weighted taxonomy of NFTs, determining a match based on the interest and the taxonomy, providing guidance for the new user and a user (or users) whose NFTs were used to create the taxonomy, executing an NFT sale or trade, recording the transaction in blockchain, configuring the NFT marketplace to act as an intermediary, updating taxonomies, determining weights for taxonomies, delegating sale or trade of NFT to a broker, determining delegation rights provided o the broker, determining approvals required for broker to conduct the NFT transaction, approving or denying transactions, allocating servers and virtual locations for interested users to meet, guiding users via visual cues, deep-linking users to an egress of a location to meet, and performing functions related to all other processes and features described herein.

Computing device 318 receives a user input 304 at input circuitry 316. For example, computing device 318 may receive data relating to buyer interest, seller NFTs, NFT metadata, price queries, bids, trustworthiness scores and input from XR devices.

Transmission of user input 304 to computing device 318 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, or any other suitable wireless transmission protocol. Input circuitry 316 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, or other wireless transmission protocols.

Processing circuitry 340 may receive input 304 from input circuit 316. Processing circuitry 340 may convert or translate the received user input 304 that may be in the form of voice input into a microphone, or movement or gestures to digital signals. In some embodiments, input circuit 316 performs the translation to digital signals. In some embodiments, processing circuitry 340 (or processing circuitry 326, as the case may be) carries out disclosed processes and methods. For example, processing circuitry 340 or processing circuitry 326 may perform processes as described in FIGS. 1-2, 6-7, 18 and 20, respectively.

FIG. 4 is a block diagram of an electronic device for enabling NFTs and facilitating an NFT transaction in a virtual/metaverse and delegating an NFT to another user for brokering, in accordance with some embodiments of the disclosure. In an embodiment, the equipment device 400, is the same equipment device 302 of FIG. 3. The equipment device 400 may receive content and data via input/output (I/O) path 402. The I/O path 402 may provide audio content (e.g., such as in the speakers of an XR headset). The control circuitry 404 may be used to send and receive commands, requests, and other suitable data using the I/O path 402. The I/O path 402 may connect the control circuitry 404 (and specifically the processing circuitry 406) to one or more communications paths or links (e.g., via a network interface), any one or more of which may be wired or wireless in nature. Messages and information described herein as being received by the equipment device 400 may be received via such wired or wireless communication paths. I/O functions may be provided by one or more of these communications paths or intermediary nodes but are shown as a single path in FIG. 4 to avoid overcomplicating the drawing.

The control circuitry 404 may be based on any suitable processing circuitry such as the processing circuitry 406. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 or i9 processor).

In client-server-based embodiments, the control circuitry 404 may include communications circuitry suitable for detecting linking of crypto wallet account that is associated with NFTs with a virtual world or Metaverse account, determining that a plurality of NFTs from the crypto wallet account are displayed, generating a weighted taxonomy for the NFTs displayed, determining interest of a new user in relation to the taxonomy of NFTs generated, determining a match based on the interest and the taxonomy, providing guidance for the new user and a user (or users) whose NFTs were used to create the taxonomy, executing an NFT sale or trade, recording the transaction in blockchain, configuring the NFT marketplace to act as an intermediary, updating taxonomies, determining weights for taxonomies, delegating sale or trade of NFT to a broker, determining delegation rights provided o the broker, determining approvals required for broker to conduct the NFT transaction, approving or denying transactions, allocating servers and virtual locations for interested users to meet, guiding users via visual cues, deep-linking users to an egress of a location to meet, and performing functions related to all other processes and features described herein.

The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of primary equipment devices, or communication of primary equipment devices in locations remote from each other (described in more detail below).

Memory may be an electronic storage device provided as the storage 408 that is part of the control circuitry 404. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, gaming consoles, gaming media, or any other suitable fixed or removable storage devices, and/or any combination of the same. The storage 408 may be used to store various types of content, (e.g., NFTs, weighted taxonomy, user interests, matching between new and existing users, trustworthiness ratings, taxonomy trees, meeting locations in the virtual world, avatars that represent the users, NFT applications, marketplace applications). Cloud-based storage, described in relation to FIG. 4, may be used to supplement the storage 408 or instead of the storage 408.

The control circuitry 404 may include audio generating circuitry and tuning circuitry, such as one or more analog tuners, audio generation circuitry, filters or any other suitable tuning or audio circuits or combinations of such circuits. The control circuitry 404 may also include scaler circuitry for upconverting and down converting content into the preferred output format of the electronic device 400. The control circuitry 404 may also include digital-to-analog converter circuitry and analog-to-digital converter circuitry for converting between digital and analog signals. The tuning and encoding circuitry may be used by the electronic device 400 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 408 is provided as a separate device from the electronic device 400, the tuning and encoding circuitry (including multiple tuners) may be associated with the storage 408.

The user may utter instructions to the control circuitry 404, which are received by the microphone 416. The microphone 416 may be any microphone (or microphones) capable of detecting human speech. The microphone 416 is connected to the processing circuitry 406 to transmit detected voice commands and other speech thereto for processing. In some embodiments, voice assistants (e.g., Siri, Alexa, Google Home and similar such voice assistants) receive and process the voice commands and other speech.

The electronic device 400 may include an interface 410. The interface 410 may be any suitable user interface, such as a remote control, mouse, trackball, keypad, keyboard, touchscreen, touchpad, stylus input, joystick, or other user input interfaces. A display 412 may be provided as a stand-alone device or integrated with other elements of the electronic device 400. For example, the display 412 may be a touchscreen or touch-sensitive display. In such circumstances, the interface 410 may be integrated with or combined with the microphone 416. When the interface 410 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 410 may be HDTV-capable. In some embodiments, the display 412 may be a 3D display. The speaker (or speakers) 414 may be provided as integrated with other elements of electronic device 400 or may be a stand-alone unit. In some embodiments, the display 412 may be outputted through speaker 414.

The equipment device 400 of FIG. 4 can be implemented in system 300 of FIG. 3 as primary equipment device 302, but any other type of user equipment suitable for allowing communications between two separate user devices for performing the functions related to enabling NFTs in a virtual world or metaverse environment, and all the functionalities discussed associated with the figures mentioned in this application.

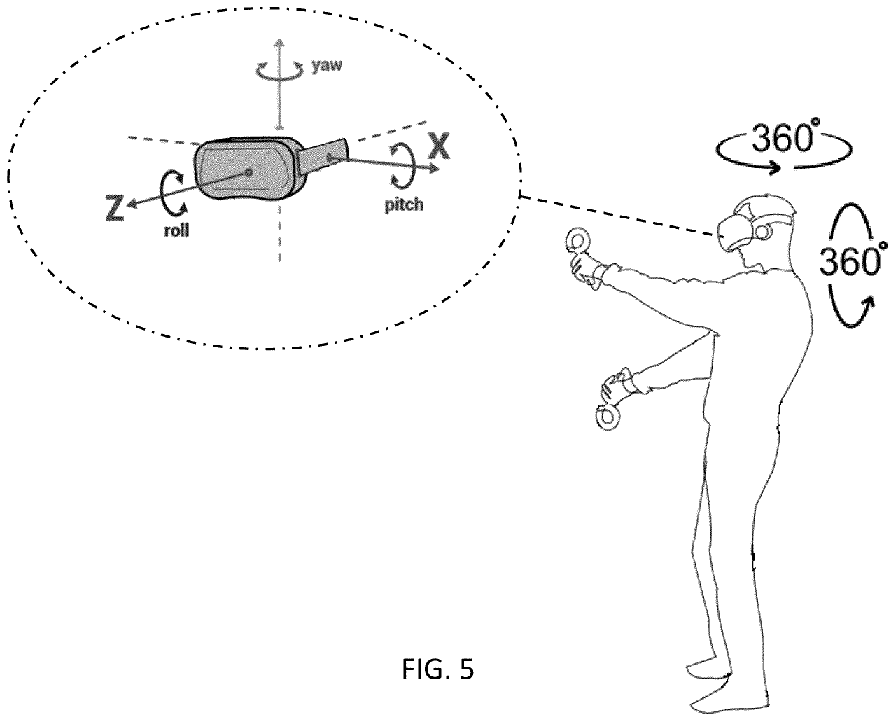

FIG. 5 is an example of an electronic device used in the virtual/metaverse environment for performing NFT transactions, in accordance with some embodiments of the disclosure. In some embodiments, the extended reality devices, such as headsets, glasses, mobile phones, or other wearable devices, may be used to perform the processes described herein. The extended reality devices may be non-immersive, fully immersive, semi-immersive or have some other combination of virtual, augmented, or mixed reality. For example, the extended reality device may be an Oculus Rift™, Oculus Quest™, Valve Index™, or a Sony PlayStation VR™. It may also be smart/virtual glasses such as Iristick Z1™, Epson Moverio BT-200™, Microsoft Hololens™, Nreal Air™ or Sony SmartEyeglass™.

In some embodiments, the headsets may be a virtual reality headset where NFTs can be visualized. In some embodiments, the extended reality device may include a complete system with a processor and components needed to provide the full extended reality experience. In other embodiments, the extended reality device may rely on external devices to perform all the processing, e.g., devices such as smartphones, computers, and servers. For example, the headset may be a plastic, metal, or cardboard holding case that allows viewing, and it may be connected via a wire or wirelessly or via an API to a smartphone and use its screen as lenses for viewing.

As depicted in FIG. 5, in one embodiment, the extended reality headset used includes 6DOF to provide a full immersive experience where the user can view NFTs, follow direction guidance in the virtual world that leads to a location where users with similar NFT interests may meet. It also allows the user to guide their avatar in the metaverse to meet other avatars that have similar interests in similar NFTs. Although some references have been made to the type of extended reality headset, the embodiments are not so limited, and any other extended reality headset available in the market may also be used with the embodiments described herein.

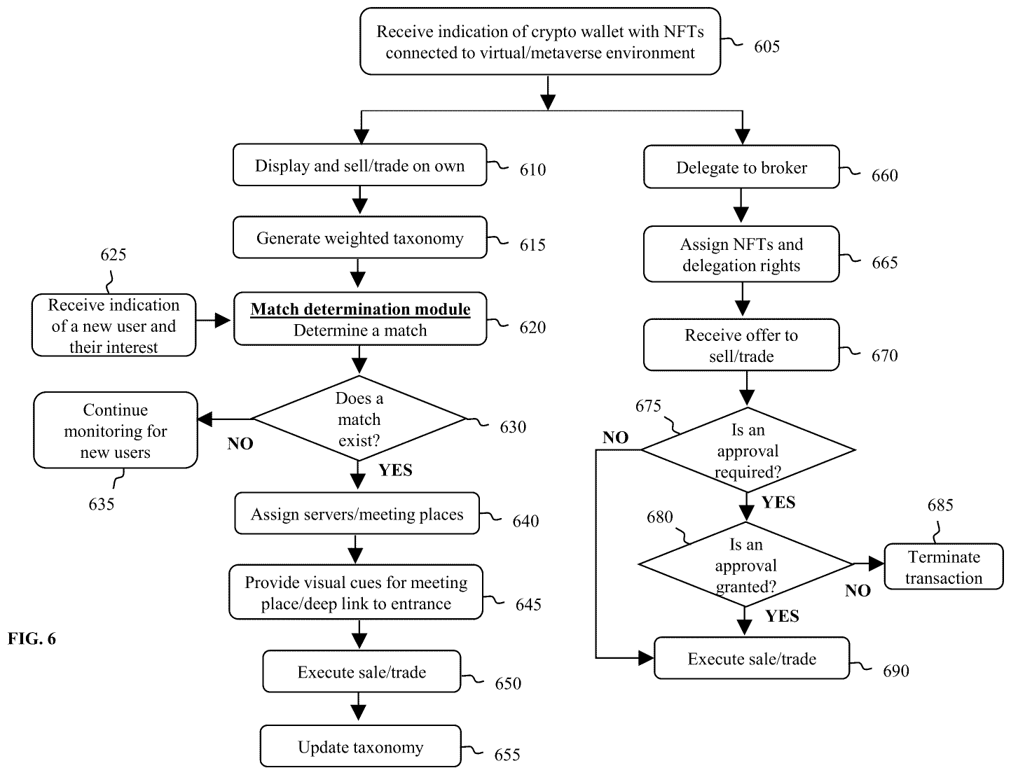

FIG. 6 is a flowchart of a process for executing NFT transactions in a virtual/metaverse environment, in accordance with some embodiments of the disclosure.

In some embodiments, at block 605, an indication is received by the control circuitry of a system, such as the system depicted in FIG. 3, that a crypto wallet that holds NFTs of a user is connected to a virtual/metaverse environment. The indication may be via a message, or another form of notification received by the control circuitry 320 and/or 328.

At block 610, the control circuitry 320 and/or 328 may determine that the owner of the NFTs has decided to display and sell or trade the NFT's on their own and without a broker. As referred to herein, trade may include exchanging NFTs with another user. Based on the NFT selected for display by the owner, the control circuitry 320 and/or 328 may generate a weighted taxonomy at block 615. In generating the weighted taxonomy, which in some embodiments is a knowledge graph or a tree, the control circuitry 320 and/or 328 may take into account the type of NFT and associate the NFT with a particular score or rating. As described further in FIG. 12, the more specific and unique the type of NFT the higher the score and rating associated with it. For example, an NFT that is categorized more generically at the top layer, such as an NFT related to a car or a painting, may get a lower weighted score than an NFT which is a few layers deeper because of its rarity and specificity, such as a vintage car or a painting by Picasso, may get a higher weighted score. In other words, the more unique or rare the NFT, the deeper it is in the weighted layers of taxonomy and is associated with a higher weighted score.

The weighted taxonomy at block 615 may be generated for one user who is looking to display and sell or trade their NFTs or multiple users that are looking to display and sell or trade their NFTs. As more and more users get added to the taxonomy, the graph or tree continues to grow with each addition or have more NFTs in one branch or leaf of the tree based on similarity of NFTs. For example, two NFTs that share characteristics and genre may be on the same branch or layer of the taxonomy.

At block 620, the control circuitry 320 and/or 328 may utilize a match determining module to determine a match between a new user and the current user or users, for whom the weighted taxonomy was generated.

Once a new user links their crypto wallet to their Metaverse account, the control circuitry 320 and/or 328 may receive a notification of a new user at block 625. In other embodiments, the notification may be received if the new user expresses an interest in the NFTs of the current users for whom the weighted taxonomy is generated.

The control circuitry 320 and/or 328 at block 625, may also determine the interest of the new user in the NFTs listed in the taxonomy. In one embodiment, user interest may be determined by the control circuitry 320 and/or 328 based on the new user NFT ownership. For example, based on similarities between the NFTs are owned by the user and the NFTs in the taxonomy, the control circuitry 320 and/or 328 may determine that the new user may be interested. In another embodiment, user interest may be determined by the control circuitry 320 and/or 328 based on the new user's browsing history, such as if the new user browsed through NFTs in the taxonomy or other NFTs elsewhere in the metaverse. In yet another embodiment, new user's interest may be determined by the control circuitry 320 and/or 328 based purchase history. For example, if the new user purchased, sold, or traded NFTs that are in the same genre or share similar characteristics as those on the NFT taxonomy, with a predetermined period of time, such as a within last 6 months, the control circuitry 320 and/or 328 may determine that the new user may have interests. Such purchase and trade history may be obtained by the control circuitry by accessing previous blockchain transactions. In another embodiment, the new user's interest may be determined based on their membership, associations, or groups to which the new user belongs and if such membership, associations, or groups are either shared by the current user or users whose NFTs are listed in the taxonomy or such membership, associations, or groups have NFTs are in the same genre or share similar characteristics as those on the NFT taxonomy. In addition to these example, the new user's interest may be obtained in several other ways.

At block 620, an analysis for matching the new user with the taxonomy may be conducted based on interests described above. At block 630, control circuitry 320 and/or 328 may determine whether a match exists. If a determination is made at block 630 that a match does not exist, then the new user is not added to the taxonomy. The control circuitry 320 and/or 328 may continue monitoring for additional new users as and perform the match analysis in step 620 once a new user has been identified at block 625.

At block 630, if a determination is made at block 630 that a match exists, then the control circuitry 320 and/or 328, at block 640, may assign a server or a meeting place such that the new user and the current user or users can meet in the virtual/metaverse environment and further explore their interests. Ask such, the control circuitry 320 and/or 328 may assign a particular server based on the type of interest between the new user and the current user(s) for which the weighted taxonomy was generated. For example, if the level of interest is in sports cars and specifically Ferraris™, then a special server that is designated for individuals with NFT interest related to sports cars and Ferrari™ may be designated as a meeting place. In some embodiments, control circuitry 320 and/or 328 may divide the virtual or metaverse world into sub-regions or zones and deep-link the new user to a portal of that zone, to ingress the virtual/metaverse world such that the new user can meet the existing users and explore a sale or trade of NFTs.

At block 645, the control circuitry 320 and/or 328 may provide visual cues for meeting place that has been designated or deep link to an entrance of a meeting place as described above. Such visual cues may allow a new user to navigate in the virtual world and reach the current and existing users to virtually come face to face and execute a trade.

At block 650, in one embodiment, a sale or trade may be executed. If a sale or trade is executed, then the new users NFTs may be added to the taxonomy, at block 655, and the taxonomy may be updated with the new user's NFTs, as further described in FIG. 7. The ownership information may also be recorded in the block chain.

Referring back to block 605, if after receiving an indication of the current user's crypto wallet being connected to the virtual/metaverse environment, a determination is made that the user has delegated the display, sale, and/or trade of their NFTs to the broker, then at blocks 660 and 665, the control circuitry 320 and/or 328 determines which delegation rights were assigned to the broker. The determination may include determining whether full set of rights or limited rights were provided to the broker for brokering a transaction for the NFTs. If full set of rights were provided, those may allow the broker to determine a price, negotiate a deal, and give them full leverage as compared to limited rights in which the broker may only exercise their brokering duties in accordance with the limited rights provided. There may also be instances where only display rights are provided, and the broker is not given any leeway on pricing or any other negotiations.

At block 670, if the broker gets an offer to sell or trade the owner's NFTs, a determination may be made at block 670 if an approval is required to execute the transaction. In some embodiments, the owner of the NFT may require an approval for certain transactions. In those embodiments, the broker may be required to obtain approvals prior to executing the transaction. Such approvals may include an approval if there's a change in sale price, transaction details etc.

At block 675, if a determination is made if an approval is required prior to executing the transaction, if it is required, then at block 680, another determination may be made whether and approval has been granted by the owner. If a determination is made at block 680 that the approval has been granted, then the sale or trade may be executed at block 690.

If at block 675 it determination is made that an approval is not required, then the process may proceed to block 690 where the sale or trade of the NFT may be executed.

At block 680 if a determination is made that an approval was not granted, then the transaction may be terminated at block 685 and the sale or trade may not be conducted.

When conducting a sale or trade, the control circuitry 320 and/or 328 may designate the system associated with the marketplace to act as a neutral intermediary party for the transaction. The system associate with the marketplace may act as an escrow to ensure that both parties, the buyer and seller, receive as negotiated for the transaction. Accordingly, the system associated with the marketplace may receive and hold the buyer's funds. The system associated with the marketplace may also ensure that the funds include any gas fees, which is a payment for the network that is used for the NFT transaction, such as Ethereum™. The system associated with the marketplace may receive the NFTs from the owner directly, not from the broker and perform the transaction by transferring the NFTs to the buyer and the funds for the NFT to the seller. Upon completion of the transaction, the crypto wallets of the buyer and seller may be updated, and the transaction may be recorded in the blockchain.

FIG. 7 is a flowchart of a process for updating NFT taxonomy as new users are added, in accordance with some embodiments of the disclosure.

The process starts at block 705 where a Match Figure of Merit (FoM) between a new user and existing taxonomy, which is generated based on NFTs of a current user or a group of users is determined. At block 705, at the outset of the process the FOM is set to zero.

At block 710, the control circuitry 320 and/or 328 determines whether the new user has any NFTs to process. If a determination is made that the new user does not have any NFTS to process, then the process is stopped at block 715. However, if a determination is made at block 710 that the new user has NFT to process, then the control circuitry 320 and/or 328 pick the next NFT at block 720 to process.

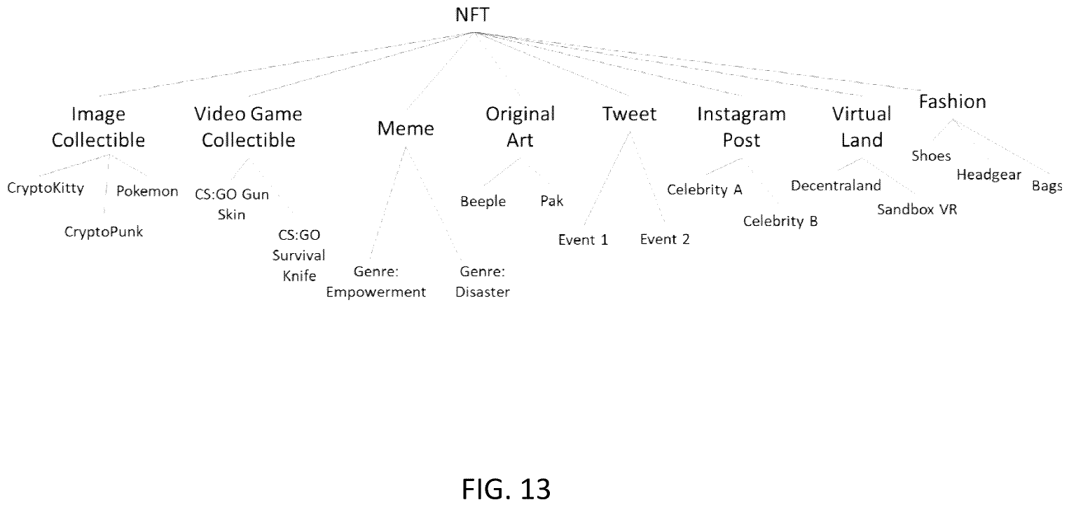

At block 725, the control circuitry 320 and/or 328 determines the next node in the tree based on the predefined taxonomy. The predefined taxonomy relates to taxonomy that has been generated based on the currently existing NFTs of the current user or users. In other words, if the current existing user or users had five different types of NFTs, then the taxonomy tree would be populated to list those five different NFTs based on their genre or characteristics. Some examples of such taxonomy trees are provided in FIGS. 13-15.

In one embodiment, if the new user has an NFT to process, then the control circuitry may determine the characteristics of the NFT including its genre and determine where on the currently existing taxonomy tree does that genre or characteristics exist. Based on the NFT between the new user and the existing taxonomy, the taxonomy tree may be updated to add the new user's NFTs.

As such, the control circuitry 320 and/or 328 at block 730 may determine whether a node exists in the taxonomy tree (also referred to herein as knowledge graph, NFT tree, or tree). In other words, does the currently existing NFT tree already has a genre or sub-genre that is identified in the new user's NFT. For example, if the currently NFT tree has a branch for sports car and a subbranch or node for Ferraris™, and the new user NFT relates to a Porsche™, then the determination may be made that and node in the sports car tree relating to Porsche™ does not exist and needs to be created.

As such, at block 730, if determination is made that a node does not exist in the taxonomy tree, then at block 745 a new node is created, and a weight of the new node is determined. At block 730, if a determination is made that the node does exist, then at block 735, the control circuitry increments match FOM by weight of edge. In other words, if the node currently includes 2 NFTs and a new NFT is added, then the weight of that node is increase to 3.

At block 740, the control circuitry 320 and/or 328 make the leaf node as the end of taxonomy. However, if there are more NFTs to process, then the process may repeat from block 710-740.

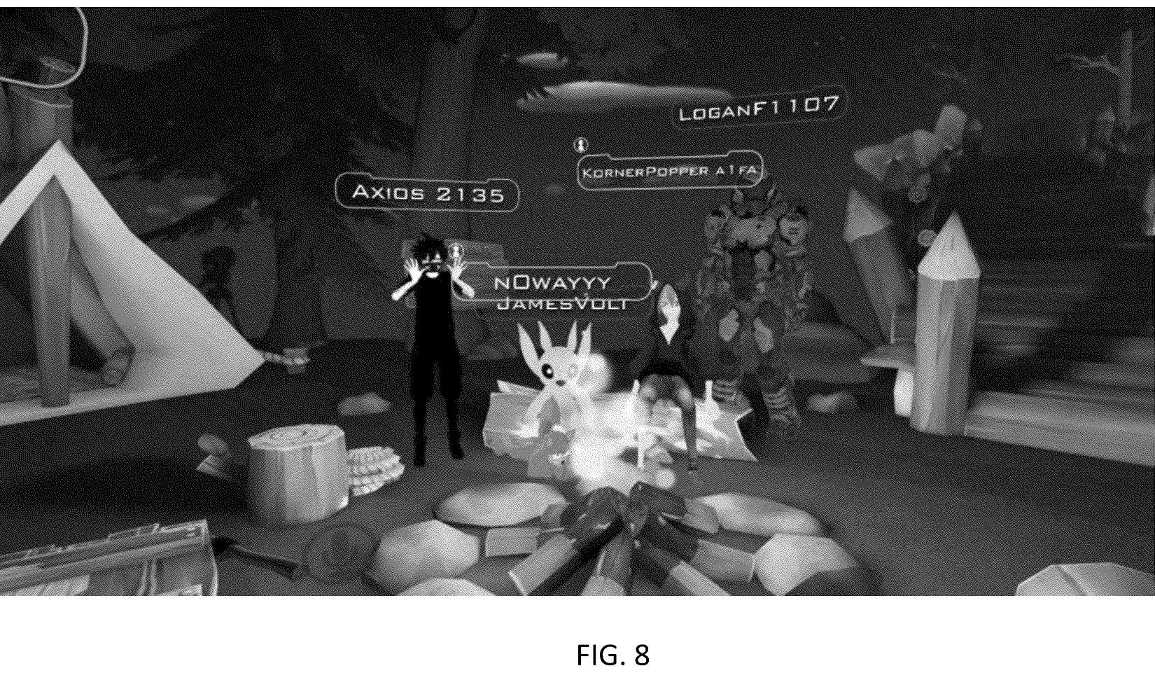

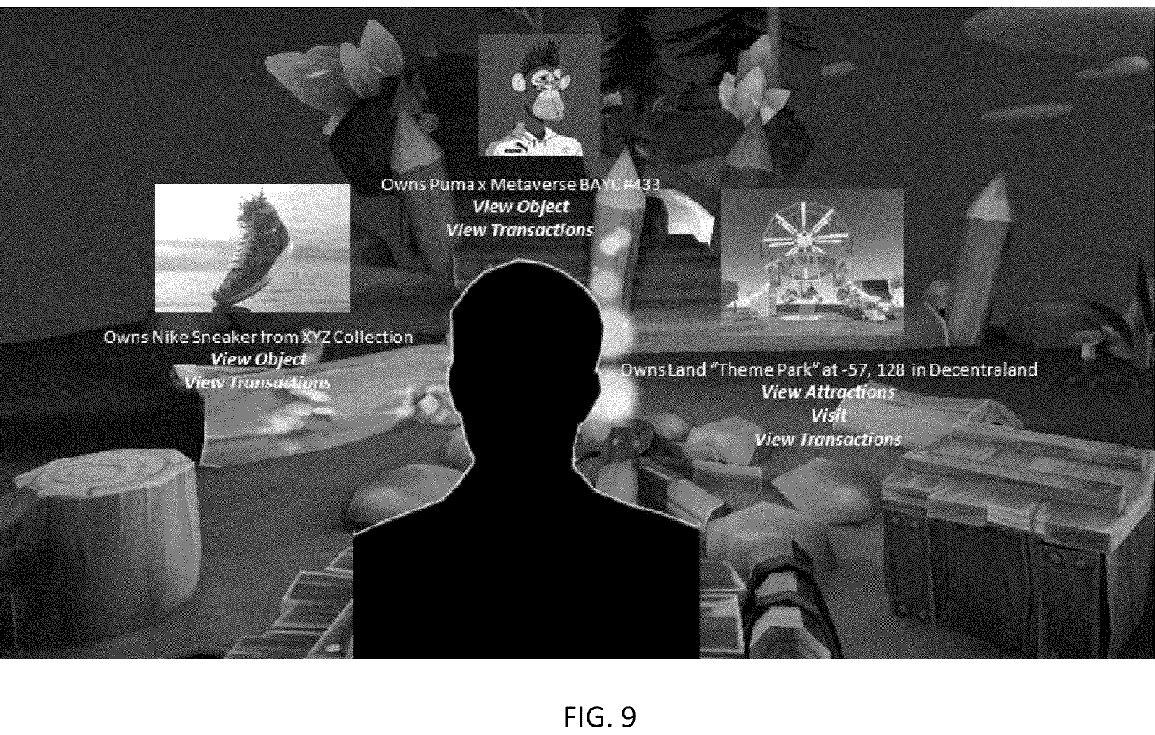

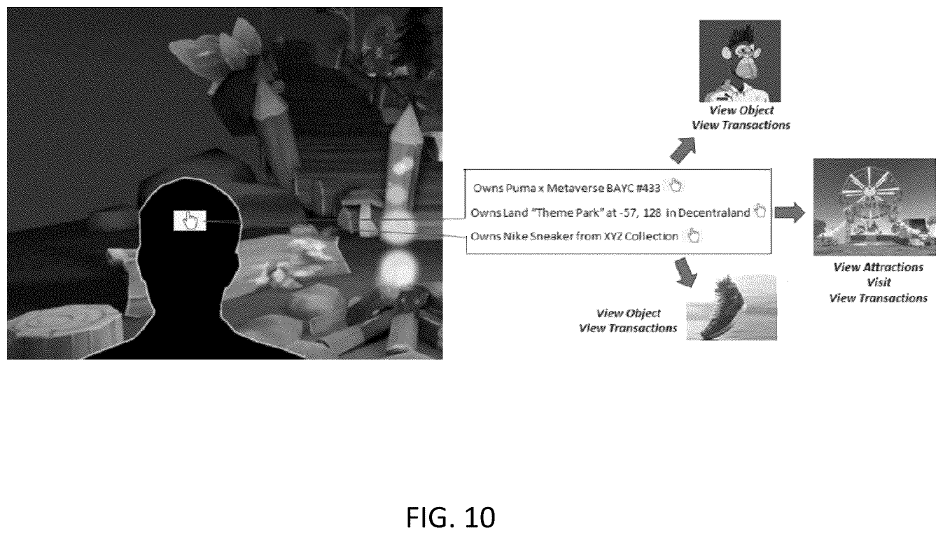

FIG. 8 is an example of avatars of multiple users coming face to face in a virtual or metaverse environment, in accordance with some embodiments of the disclosure. As described above, user via their avatars may come face to face in the virtual or metaverse world. Being face to face or are in close proximity such that they are visible to each other, in the virtual or metaverse world allows users to explore a sale or trade. When the users are face to face or in close proximity, as depicted in FIG. 9, which is an example of presentation of an NFT in the virtual or metaverse environment, the user may hover or select the NFT as in FIG. 10 to review metadata related to the NFT. For example, a second user may hover their controller or mouse over the first user to get information on which NFTs they own. Hovering on each individual element reveals more information about that NFT.

In some embodiments, FIG. 9 also depicts NFTs around a first user with key images and links that either provide more information, or an opportunity to branch off to view an NFT.

FIG. 11 depicts examples of categories that may be explored to determine a weighted score for the NFT, in accordance with some embodiments of the disclosure. In some embodiments, the control circuitry 320 and/or 328 may determine the weighted score of an NFT and/or its owner. In some instances, the creator or an NFT may be different than the owner, and in those instances, a weighted score may also be provided for the original creator of the NFT. The weighted score may be based on a plurality of factors. These factors may include NFT owner's ratings 1110, transaction history 1120, the creator's background 1130, and trustworthiness 1140.

In some embodiments, the control circuitry 320 and/or 328 may determine the weighted score based on a rating of the NFT owner at 1110. For example, these ratings may address user concerns of whether the NFT owner reputable, have they conducted transaction in a proper manner, have they followed rules and responded to questions in time, etc. The rating may have been provided by previous users that have interacted with this particular NFT owner and a cumulative rating based on all the previous ratings may be displayed to a new user looking to transact with the same owner. The rating may act as a vote of confidence provided to a new user and what to expect in dealing with an NFT owner.

In some embodiments, the control circuitry 320 and/or 328 may determine the weighted score based on the transaction history 1120 of the NFT. In this embodiment, the control circuitry 320 and/or 328 may I access all the purchases and sales of a particular NFT and determine if there were any red flags or concerns posted related to previous transactions.

In some embodiments, the control circuitry 320 and/or 328 may determine the weighted score based on the NFT creator's background 1130. In this embodiment, the control circuitry 320 and/or 328 May determine what are the NFT creator has created several other NFT's or whether this is the only NFT created. The control circuitry 320 and/or 328 may also determine the creativity and skill set of the creator and how it has been regarded in the community. Such data may be used to determine whether the NFT is of a high caliber and well regarded.

In some embodiments, the control circuitry 320 and/or 328 may determine the weighted score based on the trustworthiness 1140 or a trustworthiness score. In this embodiment, the control circuitry 320 and/or 328 may determine trustworthiness based on several factors including, common contacts or common groups, fraud or copyright issues, or how long an NFT from this seller or content creator remained online well after the transaction.

With respect to an NFT, the actual item could be located anywhere on the internet, and the NFT effectively serves as a digital pass for that internet address where the media file (image, video, etc.) is stored. While the reasons are manifold, some of the most common reasons for lack of trustworthiness in these transactions are around centralized file storage, where an NFT marketplace may not have paid their dues to keep the asset online in a cloud file system. Another reason for lack of trustworthiness is around fraud and copyright of the NFT. Yet another reason for lack of trustworthiness is related to NFT hosting sites removing the NFT from the hosted location after the sale.

In order to provide the user some level of confidence, or lack thereof, the trustworthiness rating is generated after an analysis of factors such as did previous transaction go smoothly, did NFT remain online well after the transaction, were and fraud or copyright claims made against the NFT owner of creator.

FIG. 12 depicts layers in a taxonomy tree and the weighted score of some exemplary NFTs in the tree, in accordance with some embodiments of the disclosure. In some embodiments, the weighted taxonomy may be generated based on the NFT's owned by a user or group of users. The weighted taxonomy may include a top-down approach where the highest level, or the most generic category or genre, of NFT is given a lesser weight than a deeper and more specific type of NFT that is rare.

As depicted in FIG. 12, layer 1 may include categories with four genres of NFTs with each category being associated with ownership of 1 NFTs [e.g., A (1)]. Layer 2 may include 1 NFT that is in a sub-category of genre A. Layer 3 may include 1 that is in a sub-category of a sub-category of genre C. As described earlier, the deeper the layer, the more specific and rarer the NFT and a higher the weight of such an NFT.

The control circuitry 320 and/or 328, as depicted in the table o FIG. 12, may assigned weighted scores based on the layers of the NFT. As depicted, weighted score 1 is assigned to the NFTs that are in layer 1, weighted score 2 is assigned to the NFTs that are in layer 2, and weighted score 3 is assigned to the NFTs that are in layer 3. In the event that a rare NFT exists, not shown in layers above, such as an NFT which is in the top 1% of rarity, the control circuitry 320 and/or 328 my assign it a higher weighted score than other NFTs in the taxonomy tree that are not as rare.

The weighted taxonomy may then be used by the control circuitry to determine a match with a new user. If a match with a new user exists at a deeper level, then the control circuitry may determine a higher level of match than when a match occurs at a top layer 1 level.

FIGS. 13-15 depict examples of taxonomy trees, in accordance with some embodiments of the disclosure. In one embodiment, FIG. 13 is a knowledge graph or a taxonomy tree generated by the control circuitry in which the control categorizes each users' NFTs. As depicted, in this embodiment, the tree (or a knowledge graph without loops) that is used to build the properties associated with each user's NFTs, is a non-exhaustive categorization of NFTs based on 2 levels. An exhaustive categorization may include more types and levels.

Once the NFTs associated with any user have been retrieved, they are categorized by the metaverse platform or a third party or by the control circuitry. In one embodiment, crowdsourcing may be used to categorize a user's NFTs. For example, a second user can be asked to categorize a first user's displayed NFTs. This can repeat until a clear winner (a mode in a distribution) is determined.

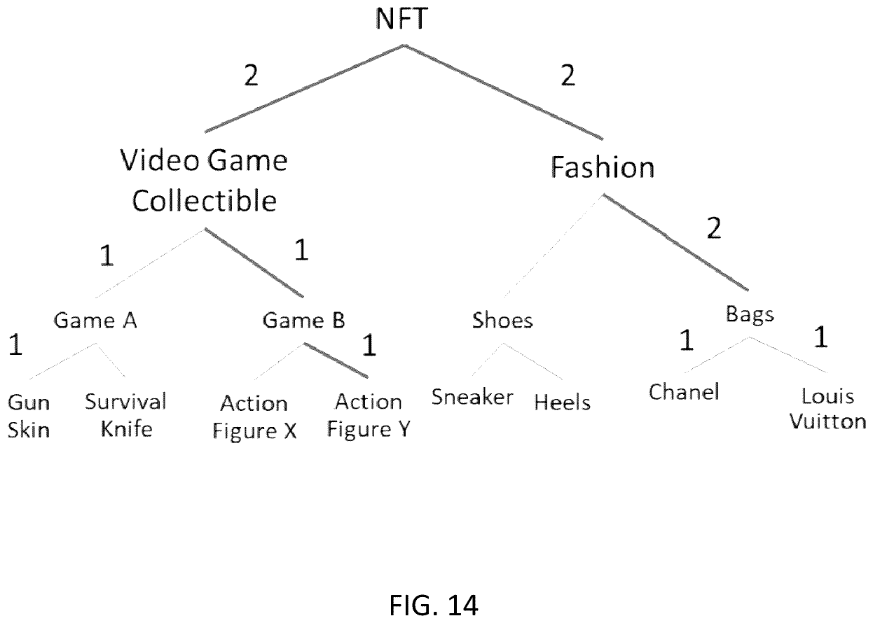

When a new user requests to join the metaverse, then the metaverse app determines which server to assign to the new user based on the number of matches in the category tree between the online users on existing servers and the new user. Each subsequent level (depth) in the taxonomy tree traversal cumulatively increases the match than the previous level. For example, if one user has an NFT video game collectible then the match with another user that also has a video game collectible is 1. But if two users both have a video game collectible for the same game (Say, Counterstrike Global Offensive), then their mutual match is higher, in this case 1+1=2. Other embodiments, such as in FIG. 14 may also exists in which the current online users have 4 NFTs categorizations.

In one embodiment, FIG. 14 depicts an example server with online users or owners that own NFTs. In this embodiment, a new user who has one (3D model) Action Figure Y NFT (Game B) and one (3D model) Prada bag NFT may requests to join the virtual or metaverse world. Then the match of new user to the online users on this server is given by:
Depth Level 1: 2 (Video Game Collectible)+2 (Fashion)
Depth Level 2: 1 (Game B)+2 (Bags)
Depth Level 3: 1 (Action Figure Y)
   Thus, a cumulative Match Figure of Merit (FoM) between this new user and the online server has a value of 8. The traversed paths are shown with thicker edges.

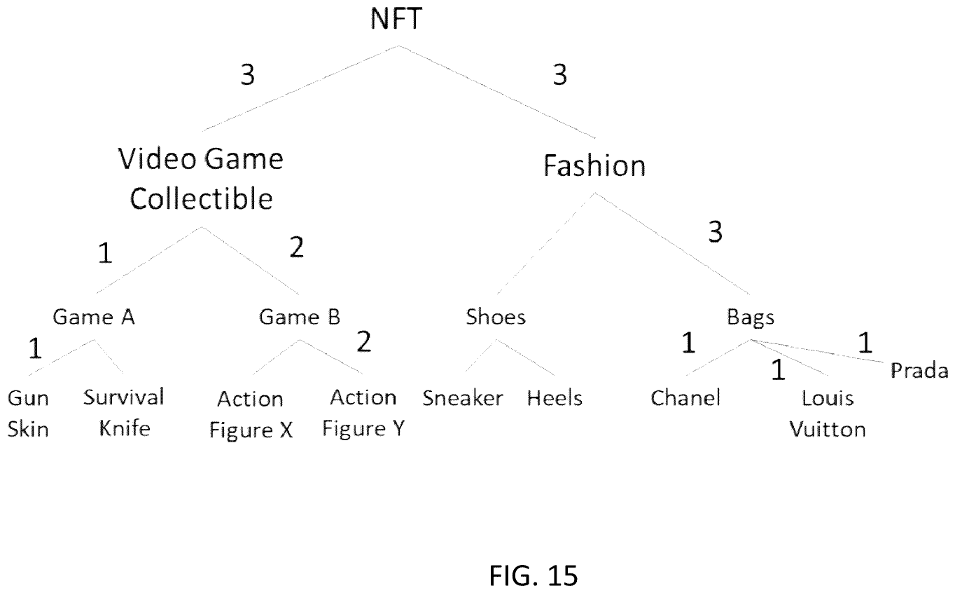

In this manner, in one embodiment, the Match Figures of Merit for each online server is calculated by the control circuitry and the new user is joined to the server with the highest Match FoM. If the user cannot join the highest Match FoM due to system considerations (such as the server user capacity has already been reached), then the next highest FoM candidate server is chosen. Once the user joins a server, then the user's NFT ownership is used to update the NFT tree for that server. The updated tree is depicted in FIG. 15.

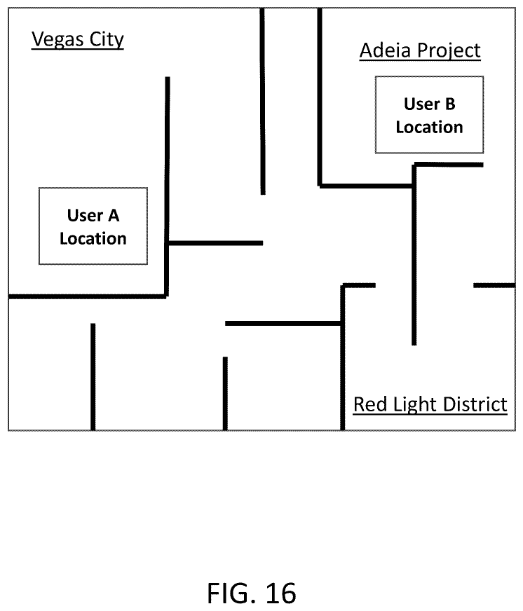

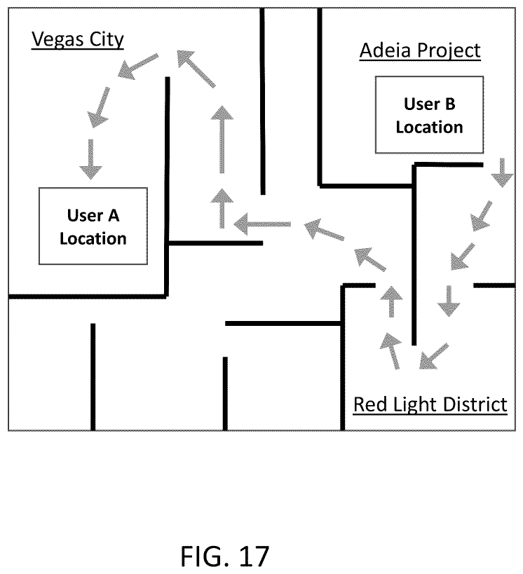

FIG. 16 is an example of a virtual or metaverse environment where multiple users may meet each other to facilitate an NFT transaction, in accordance with some embodiments of the disclosure. A virtual environment with different zones or rooms with designations such as Vegas city, Red Light District, Adeia project and others are depicted. If user Y matches with a user X that is in a different location of the virtual or metaverse environment, then, as depicted in FIG. 17, visual cues may be provided to a user Y and/or X to navigate in the virtual or metaverse environment to meet the other user since a determination has been made that the two users have common interests in a type of NFT. As depicted in in FIG. 17, visual cues may include arrows pointing in the direction where the other user is located such that either user X and/or Y may navigate in the virtual world using the cues to come face to face or within a close proximity of another. In another embodiment, the control circuitry may determine a common location where both users can be transported using the visual cues for a face to face or close proximity meeting. As described above, in addition to such navigational support, the control circuitry may also deep-link each user such that they're placed or transported to the ingress of a location where a meeting is to be taken place.

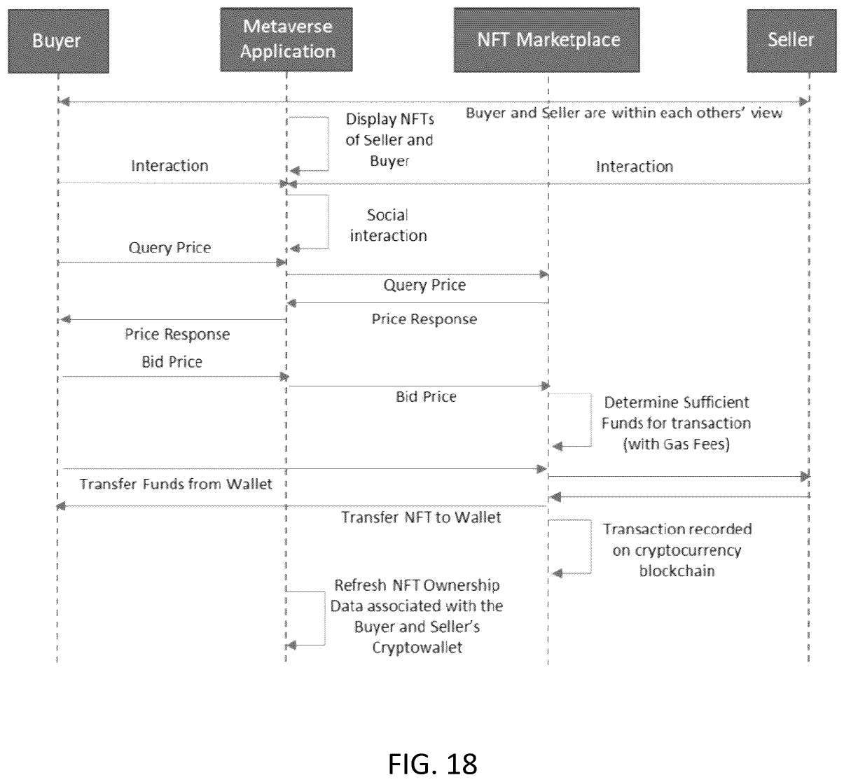

FIG. 18, the is a flowchart of a process of communications between a buyer, seller, metaverse application, and NFT marketplace to execute an NFT transaction, in accordance with some embodiments of the disclosure. In one embodiment, a buyer and seller may be within each other's view. The metaverse application may display NFT's of the seller so that they can be viewed by the buyer. If the buyer has NFTs, they may also be displayed. The buyer and seller may interact with each other in a social interaction and query details such as price, make bids, and determine whether the buyer has sufficient funds to transact and purchase or trade with the seller. Once the querying stage and funds verification stage is completed, the funds from the buyer may be transferred to the NFT marketplace along with the NFTs from the seller also to the NFT marketplace. This transfer may allow the NFT marketplace to act like an intermediary or an escrow holder in facilitating the transaction. The NFT marketplace may then allow the transaction to take place. Upon completion of the transaction, the NFT marketplace may record the transaction of the cryptocurrency blockchain as well as update the NFT ownership for the buyer and seller in their crypto wallets.

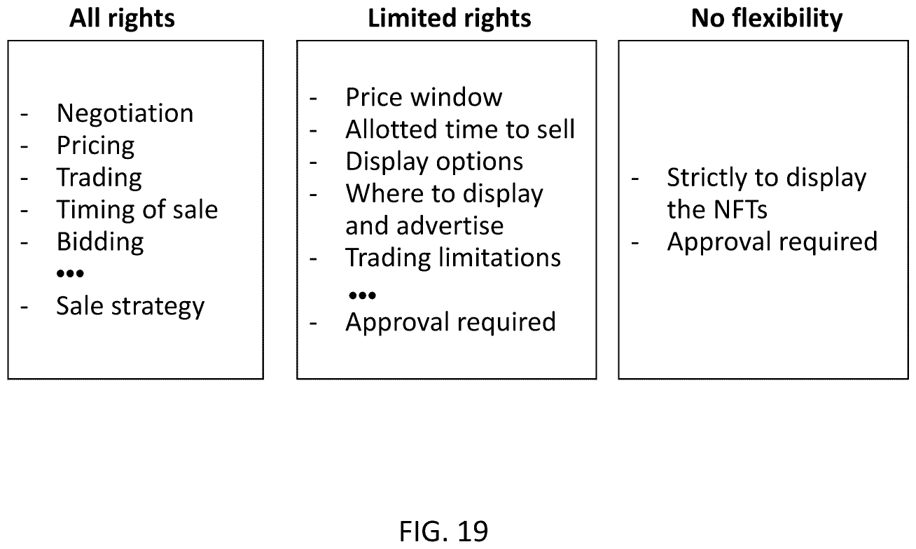

FIG. 19 is an example of rights provided to a broker to execute an NFT transaction, in accordance with some embodiments of the disclosure. In this embodiment, different categories of rights may be awarded from an owner or seller to a delegate, also referred to herein as a broker. In one embodiment, all rights may be provided to the broker. These rights may include negotiation, pricing, trading, timing of sale, bidding, and sales strategy rights. Under these rights the broker may perform any and all functions needed to display and to execute a transaction with a buyer.

In another embodiment, the owner of the NFT may provide limited rights to the broker. These limited rights may limit the broker within the price window, within an allotted time to sell, restrict their display options, define where the broker can display and advertise, place trading limitations, and requiring approval prior to execution of the transaction. For example, the owner may provide the broker a price window of sale between $2000 and $3000 for a particular NFT. Such limited rights may allow the broker to negotiate a deal as long as the purchase price is within the price window of $2000 to $3000. If the broker is able to secure a deal within that price window, the broker may need approval from the owner prior to executing the transaction, if such reprove approval is required.

In yet another embodiment, the owner of the NFT may provide no flexibility to the broker and strictly restrict their rights to displaying the NFTs and obtaining an approval prior to conducting a transaction.

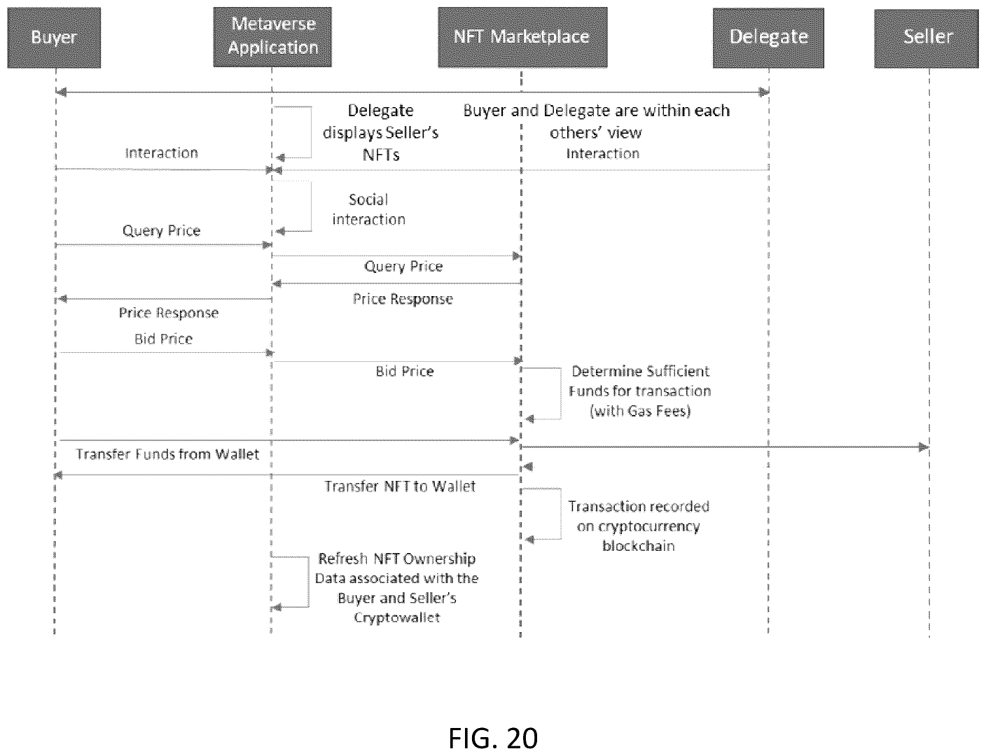

FIG. 20 is a flowchart of a process of communications between a buyer, seller, delegate (broker), metaverse application, and NFT marketplace to execute an NFT transaction, in accordance with some embodiments of the disclosure. In this embodiment, a buyer and delegate (broker) maybe within each other's view. In another embodiment, the buyer and broker may not be within each other's view, however a buyer may designate the broker, to display their NFTs and execute a transaction based on the rights provided to the broker. Some examples of rights provided to the broker are described in relation to discussion of FIG. 19.

In one embodiment, the seller and broker may interact with each other in a social interaction and query details such as price, bids, and exchange all information needed for the broker to display the NFTs of the owner in an effort to execute a transaction with a potential buyer. Once a buyer is identified, and upon completion of the querying stage and buyer funds verification, the funds from the buyer may be transferred to the NFT marketplace along with the NFTs from the seller also to the NFT marketplace. This transfer may allow the NFT marketplace to act like an intermediary or an escrow holder in facilitating the transaction. The NFT marketplace may then allow the transaction to take place. Upon completion of the transaction, the NFT marketplace may record the transaction of the cryptocurrency blockchain as well as update the NFT ownership for the buyer and seller in their crypto wallets. In this embodiment, the broker does not obtain the buyer's money nor does the broker get the owner's NFTs, all that is performed by the NFT marketplace, and the broker is only given right to display and advertise the NFTs in an attempt to secure a buyer. Additional rights, as described in FIG. 19 may also be provided to the broker.

It will be apparent to those of ordinary skill in the art that methods involved in the above-mentioned embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method of executing an NFT transaction by using an NFT broker in a virtual environment comprising:
receiving an offer on NFT delegated to a broker, wherein the offer is to sell or trade the NFT to a second user;
in response to determining that the NFT was delegated to a broker to sell or trade the NFT:
determining a set of delegation rights were provided to the broker;
determining that the set of rights require an approval of an NFT transaction related to the delegated NFT prior to its execution;
determining that an approval was obtained;
executing the NFT transaction; and
recording the transaction in a blockchain.

2. The method of claim 1, further comprising:
determinizing that a plurality of NFTs are displayed in a virtual environment;
receiving an indication that the NFT delegated to the broker for brokering was selected from the plurality of NFTs displayed.

3. The method of claim 3, wherein the NFT is delegated to the broker either privately or publicly.

4. The method of claim 1, wherein the delegation rights restrict the broker to displaying the NFTs in a virtual environment selected by the broker.

5. The method of claim 1, wherein the delegation rights allow the broker to negotiate a price for a sale of the NFT.

6. The method of claim 5, wherein a price window is defined within which the broker may negotiate the price for the sale.

7. The method of claim 1, wherein the NFT transaction is a sale of the NFT from a current owner to a buyer.

8. The method of claim 7, wherein the recording of the transaction in the blockchain identifies ownership of the NFT with the buyer after the transaction has been completed.

9. The method of claim 1, wherein the NFT transaction is an exchange of NFTs between a current owner and another user.

10. The method of claim 1, further comprising, determining that a buyer of the NFT has funds for conducting the NFT transaction.

11. A system of executing an NFT transaction by using an NFT broker in a virtual environment comprising:
control circuitry configured to:
receive an offer on NFT delegated to a broker, wherein the offer is to sell or trade the NFT to a second user;
in response to determining that the NFT was delegated to a broker to sell or trade the NFT, the control circuitry configured to:
determine a set of delegation rights were provided to the broker;
determine that the set of rights require an approval of an NFT transaction related to the delegated NFT prior to its execution;
determine that an approval was obtained;
execute the NFT transaction; and
record the transaction in a blockchain.

12. The system of claim 11, further comprising, the control circuitry configured to:
determine that a plurality of NFTs are displayed in a virtual environment;
receive an indication that the NFT delegated to the broker for brokering was selected from the plurality of displayed NFTs.

13. The system of claim 11, wherein the NFT is delegated to the broker either privately or publicly.

14. The system of claim 11, wherein the delegation rights restrict the broker to displaying the NFTs in a virtual environment selected by the broker.

15. The system of claim 11, wherein the delegation rights allow the broker to negotiate a price for a sale of the NFT.

16. The system of claim 15, wherein a price window is defined within which the broker may negotiate the price for the sale.

17. The system of claim 11, wherein the NFT transaction is a sale of the NFT from a current owner to a buyer.

18. The system of claim 17, wherein the recording of the transaction in the blockchain identifies ownership of the NFT with the buyer after the transaction has been completed.

19. The system of claim 11, wherein the NFT transaction is an exchange of NFTs between a current owner and another user.

20. The system of claim 11, further comprising, the control circuitry configured to determine that a buyer of the NFT has funds for conducting the NFT transaction.
